(19) United States
(12) Patent Application Publication
(10) Pub. No.: US 2023/0343952 A1
(43) Pub. Date: Oct. 26, 2023

(54) SECONDARY BATTERY, MANUFACTURING METHOD OF SECONDARY BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Yohei MOMMA, Isehara, Kanagawa (JP); Mayumi MIKAMI, Atsugi, Kanagawa (JP); Teruaki OCHIAI, Atsugi, Kanagawa (JP)

(21) Appl. No.: 18/002,197

(22) PCT Filed: Jun. 15, 2021
(86) PCT No.: PCT/IB2021/055239

§ 371 Date: Dec. 16, 2022

(30) Foreign Application Priority Data
Jun. 26, 2020 (JP) 2020-110840

(51) Int. Cl. H01M 4/525; H01M 4/1315; H01M 10/04; H01M 4/04; C01G 51/00

(52) U.S. Cl. CPC H01M 4/525; H01M 4/1315; H01M 10/049; H01M 4/0471; C01G 51/42; H01M 2004/028

(57) ABSTRACT

A positive electrode active material with high charge and discharge capacity is provided. A positive electrode active material with high charge and discharge voltage is provided. A positive electrode active material that hardly deteriorates is provided. The positive electrode active material is formed through a plurality of heating steps. The second and subsequent heating steps are preferably performed at a temperature higher than or equal to 742° C. and lower than or equal to 920° C. for longer than or equal to an hour and shorter than or equal to 10 hours. Through the heating, magnesium, fluorine, and the like are distributed in a surface portion of the positive electrode active material with preferable concentrations. The crystal structure of general lithium cobalt oxide is easily broken because it becomes the H1-3 phase type crystal structure when being charged at 4.6 V; on the other hand, the positive electrode active material of the present invention has a small ratio of the H1-3 type crystal structure when being charged at 4.6 V, and has the O3′ type crystal structure where a change in the crystal structure from discharging is relatively small, and thus has excellent cycle performance.

### TECHNICAL FIELD

Embodiments of the present invention relate to a secondary battery including a positive electrode active material and a manufacturing method thereof. Other embodiments of the present invention relate to a portable information terminal, a vehicle, and the like each including a secondary battery.

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification and the like mean all devices including power storage devices, and electro-optical devices including power storage devices, information terminal devices including power storage devices, and the like are all electronic devices.

Note that in this specification and the like, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Thus, improvement of a positive electrode active material has been studied to increase the charge and discharge cycle performance and the capacity of the lithium-ion secondary battery (e.g., Patent Document 1 and Non-Patent Document 1). Moreover, the crystal structure of a positive electrode active material has been studied (Non-Patent Document 2 to Non-Patent Document 4).

The performances required for power storage devices are safe operation and longer-term reliability under various environments, for example.

### REFERENCE

### Patent Document

[Patent Document 1] Japanese Translation of PCT International Application No. 2014-523840

### Non-Patent Document

[Non-Patent Document 1] Jae-Hyun Shim et al., “Characterization of Spinel LiₓCo₂O4-Coated LiCoO₂ Prepared with Post-Thermal Treatment as a Cathode Material for Lithium Ion Batteries”, CHEMISTRY OF MATERIALS, 27, 2015, p. 3273-3279.
[Non-Patent Document 2] Toyoki Okumura et al., “Correlation of lithium ion distribution and X-ray absorption near-edge structure in 03- and 02 lithium cobalt oxides from first-principle calculation”, Journal of Materials Chemistry, 2012, 22, pp. 17340-17348.
[Non-Patent Document 3] T. Motohashi et al., “Electronic phase diagram of the layered cobalt oxide system LiₓCoO₂ (0.0≤x≤1.0)”, Physical Review B, 80 (16); 165114.
[Non-Patent Document 4] Zhaohui Chen et al., “Staging Phase Transitions in LiₓCoO₂”, Journal of The Electrochemical Society, 2002, 149 (12) A1604-A1609.

### SUMMARY OF THE INVENTION

### Problems to be Solved by the Invention

An object of one embodiment of the present invention is to provide a positive electrode active material with high energy density and high charge and discharge capacity. Another object is to provide a positive electrode active material with high charge and discharge voltage. Another object is to provide a positive electrode active material that hardly deteriorates. Another object is to provide a novel positive electrode active material. Another object is to provide a secondary battery with high energy density and high charge and discharge capacity. Another object is to provide a secondary battery with high charge and discharge capacity. Another object is to provide a secondary battery with high charge and discharge voltage. Another object is to provide a highly safe or reliable secondary battery. Another object is to provide a secondary battery which hardly deteriorates. Another object is to provide a long-life secondary battery.

Another object of one embodiment of the present invention is to provide an active material, a power storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

### Means for Solving the Problems

One embodiment of the present invention is a secondary battery comprising a positive electrode. A positive electrode active material of the positive electrode comprises lithium, a first metal, a second metal, oxygen, and fluorine. The first metal is at least one of cobalt, nickel, and manganese. The second metal is at least one of magnesium, aluminum, titanium, zirconium, niobium, lanthanum, yttrium, and hafnium. The second metal and fluorine unevenly distributed in a surface portion of the positive electrode active material.

In the above, it is preferable that the second metal be magnesium, the concentration of magnesium in the surface portion of the positive electrode active material be greater than or equal to 4.5 atomic %, and each of magnesium and fluorine have a higher concentration as closer to a surface of the positive electrode active material, and have a concentration gradient in which the concentration decreases to ¼ or lower at a depth of 10 nm from the surface.

Another embodiment of the present invention is a method of manufacturing a secondary battery. The secondary battery comprises a positive electrode. The positive electrode comprises a positive electrode active material. The positive electrode active material is manufactured through a first manufacturing step to a third manufacturing step. The first manufacturing step, a lithium source, a first metal source, a second metal source, and a fluorine source are mixed to form a mixture. In the second manufacturing step, the mixture formed in the first manufacturing step is heated to form a composite oxide. In the third manufacturing step, the composite oxide formed in the second manufacturing step is heated.

Another embodiment of the present invention is a method of manufacturing a secondary battery. The secondary battery comprises a positive electrode. The positive electrode comprises a positive electrode active material. The positive electrode active material is manufactured through a first manufacturing step to a third manufacturing step. In the first manufacturing step, a lithium source, a first metal source, a second metal source, and a fluorine source are mixed to form a mixture. In the second manufacturing step, the mixture formed in the first manufacturing step is put in a container, the container is covered with a lid, and heating is performed to form a composite oxide. In the third manufacturing step, the composite oxide formed in the second manufacturing step is put in a container, the container is covered with a lid, and heating is performed.

In the above, it is preferable that the heating in the second manufacturing step be performed at a temperature higher than or equal to 900° C. and lower than or equal to 1100° C. for longer than or equal to 5 hours and shorter than or equal to 20 hours, and the heating in the third manufacturing step be performed at a temperature higher than or equal to 742° C. and lower than or equal to 920° C. for longer than or equal to an hour and shorter than or equal to 10 hours.

Another embodiment of the present invention is a secondary battery including a positive electrode. The positive electrode and a lithium ion secondary battery that uses lithium metal for a negative electrode are subjected to constant current charging in an environment of 25° C. until battery voltage becomes 4.6 V, and subjected to constant voltage charging until a current value becomes 0.01 C, and then the positive electrode is analyzed by powder X-ray diffraction with use of CuKα1 line. Integration with 20 of greater than or equal to 18.00° and less than 19.30° is an area intensity I_{H1-3(006)}. Integration with 2θ of greater than or equal to 19.30° and less than or equal to 20.00° is an area intensity I_{O3′+O3(003)}. The area intensity I_{H1-3(006)}/I_{O3′+O3(003)} is less than or equal to 60%.

In the above, it is preferable that the half width of a peak with 2θ of greater than or equal to 18.5° and less than or equal to 20° be less than or equal to 0.2°, and the half width of a peak with 2θ of greater than or equal to 45° and less than or equal to 46° be less than or equal to 0.2°.

Another embodiment of the present invention is an electronic device including the above-described secondary battery.

Another embodiment of the present invention is a vehicle including the above-described secondary battery.

### Effect of the Invention

One embodiment of the present invention can provide a positive electrode active material with high energy density and high charge and discharge capacity. A positive electrode active material with high energy density and high charge and discharge voltage can be provided. A positive electrode active material that hardly deteriorates can be provided. A novel positive electrode active material can be provided. A secondary battery with high energy density and high charge and discharge capacity can be provided. A secondary battery with high charge and discharge capacity can be provided. A secondary battery with high charge and discharge voltage can be provided. A highly safe or reliable secondary battery can be provided. A secondary battery which hardly deteriorates can be provided. A long-life secondary battery can be provided. A novel secondary battery can be provided.

With one embodiment of the present invention, a novel material, a novel active material, a novel power storage device, or a manufacturing method thereof can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A is a cross-sectional view of a positive electrode active material. FIG. 1B to FIG. 1C2 are diagrams illustrating distribution of elements included in a positive electrode active material.

FIG. 2A1 to FIG. 2C2 are diagrams illustrating distribution of elements included in a positive electrode active material.

FIG. 3 is an example of a TEM image showing crystal orientations substantially aligned with each other.

FIG. 4A is an example of a STEM image showing crystal orientations substantially aligned with each other. FIG. 4B shows an FFT of a rock-salt crystal RS region, and FIG. 4C shows an FFT of a layered rock-salt crystal LRS region.

FIG. 5 is a diagram illustrating the charge depth and crystal structures of a positive electrode active material of one embodiment of the present invention.

FIG. 6 shows XRD patterns calculated from crystal structures.

FIG. 7 is a diagram illustrating the charge depth and crystal structures of a positive electrode active material for a comparison example.

FIG. 8 shows XRD patterns calculated from crystal structures.

FIG. 9A and FIG. 9B are diagrams illustrating examples of a method of forming a positive electrode active material.

FIG. 10 is a diagram illustrating a method of manufacturing a positive electrode active material.

FIG. 11A to FIG. 11D are cross-sectional views illustrating examples of a positive electrode of a secondary battery.

FIG. 12A is an exploded perspective view of a coin-type secondary battery, FIG. 12B is a perspective view of a coin-type secondary battery, and FIG. 12C is a cross-sectional perspective view of a coin-type secondary battery.

FIG. 13A illustrates an example of a cylindrical secondary battery, FIG. 13B illustrates an example of a cylindrical secondary battery, FIG. 13C illustrates an example of a plurality of cylindrical secondary batteries, and FIG. 13D illustrates an example of a power storage system including a plurality of cylindrical secondary batteries.

FIG. 14A and FIG. 14B are diagrams illustrating examples of a secondary battery, and FIG. 14C is a diagram illustrating the internal state of a secondary battery.

FIG. 15A to FIG. 15C are diagrams illustrating an example of a secondary battery.

FIG. 16A and FIG. 16B are external views of a secondary battery.

FIG. 17A to FIG. 17C are diagrams illustrating a method of manufacturing a secondary battery.

FIG. 18A to FIG. 18C illustrate structural examples of a battery pack.

FIG. 19A and FIG. 19B are diagrams illustrating examples of a secondary battery.

FIG. 20A to FIG. 20C are diagrams illustrating examples of a secondary battery.

FIG. 21A and FIG. 21B are diagrams illustrating examples of a secondary battery.

FIG. 22A is a perspective view of a battery pack of one embodiment of the present invention, FIG. 22B is a block diagram of a battery pack, and FIG. 22C is a block diagram of a vehicle having a motor.

FIG. 23A to FIG. 23D are diagrams illustrating examples of vehicles.

FIG. 24A and FIG. 24B are diagrams illustrating power storage devices of one embodiment of the present invention.

FIG. 25A is a diagram illustrating an electric two-wheel vehicle, FIG. 25B is a diagram illustrating a secondary battery of an electric bicycle, and FIG. 25C is a diagram illustrating an electric motorcycle.

FIG. 26A to FIG. 26D are diagrams illustrating examples of electronic devices.

FIG. 27A illustrates examples of wearable devices, FIG. 27B is a perspective view of a watch-type device, and FIG. 27C is a diagram illustrating a side surface of a watch-type device.

FIG. 28A and FIG. 28B are graphs showing the cycle performance of positive electrode active materials in Example.

FIG. 29 is a graph showing XRD patterns of positive electrode active materials in Example.

FIG. 30A and FIG. 30B are graphs showing XRD patterns of positive electrode active materials in Example.

FIG. 31 is a graph showing XRD patterns of positive electrode active materials in Example.

FIG. 32A and FIG. 32B are graphs showing XRD patterns of positive electrode active materials in Example.

### MODE FOR CARRYING OUT THE INVENTION

Embodiments of the present invention are described in detail below with reference to the drawings. Note that the present invention is not limited to the following descriptions, and it is readily understood by those skilled in the art that modes and details of the present invention can be modified in various ways. In addition, the present invention should not be construed as being limited to the descriptions of the embodiments below.

A secondary battery includes a positive electrode and a negative electrode, for example. A positive electrode active material is a material included in the positive electrode. The positive electrode active material is a material that performs a reaction contributing to the charge and discharge capacity, for example. Note that the positive electrode active material may partly include a material that does not contribute to the charge and discharge capacity. That is, not the entire of the positive electrode active material needs to be a region including a lithium site that contributes to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In this specification and the like, uneven distribution means that a certain element in a solid made of a plurality of elements has an uneven concentration. In particular, uneven distribution means a phenomenon in which a certain element has a high concentration in a certain place.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing a minus sign (−) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure and, in some cases, not only (hkl) but also (hkil) is used as the Miller index. Here, i is −(h+k).

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, a charge depth is a value indicating the degree of a capacity that has been charged, i.e., the amount of lithium extracted from a positive electrode, relative to the theoretical capacity of a positive electrode active material as reference. For example, in the case of a positive electrode active material having a layered rock-salt structure such as lithium cobalt oxide (LiCoO₂) or lithium nickel cobalt manganese oxide (LiNiₓCo_{y}Mn_{z}O₂ (x+y+z=1)), a charge depth of 0 indicates a state where no lithium has been extracted from the positive electrode active material; a charge depth of 0.5 indicates a state where lithium corresponding to 137 mAh/g has been extracted from the positive electrode; and a charge depth of 0.8 indicates a state where lithium corresponding to 219.2 mAh/g has been extracted from the positive electrode, relative to the theoretical capacity of 274 mAh/g as reference. In the case of an expression LiaCoO₂ (0≤a≤1), LiaCoO₂ is expressed as LiCoO₂ where a is 1 when the charge depth is 0; LiₐCoO₂ is expressed as Li_{0.5}CoO₂ where a is 0.5 when the charge depth is 0.5; and LiₐCoO₂ is expressed as Li_{0.2}CoO₂ where a is 0.2 when the charge depth is 0.8.

In this specification and the like, an approximate value of a given value X refers to a value greater than or equal to 0.9X and less than or equal to 1.1X unless otherwise specified.

In this specification and the like, an example in which a lithium metal is used as a negative electrode in a secondary battery using a positive electrode and a positive electrode active material of one embodiment of the present invention is described in some cases; however, the secondary battery of one embodiment of the present invention is not limited to this example. Another material such as graphite or lithium titanate may be used as a negative electrode, for example. The properties of the positive electrode and the positive electrode active material of one embodiment of the present invention, such as a crystal structure unlikely to be broken by repeated charging and discharging and excellent cycle performance, are not affected by the material of the negative electrode. The secondary battery of one embodiment of the present invention using lithium for a negative electrode is charged and discharged at a voltage higher than a charge voltage of approximately 4.6 V in some cases; however, charging and discharging may be performed at a lower voltage. Charging and discharging at a lower voltage may lead to the cycle performance better than that described in this specification and the like.

### Embodiment 1

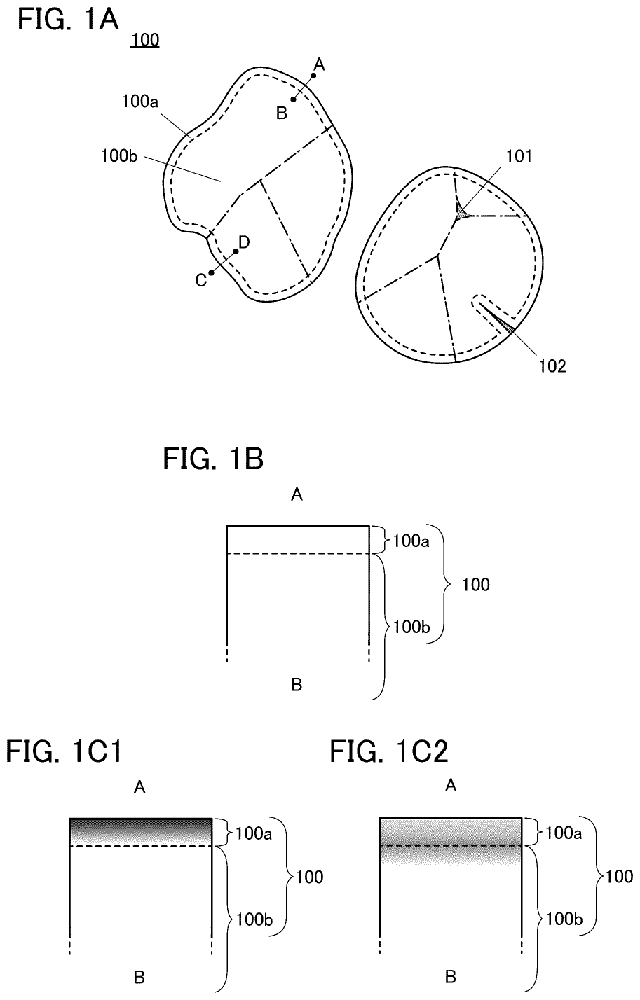

In this embodiment, a positive electrode active material of one embodiment of the present invention will be described with reference to FIG. 1A to FIG. 4.

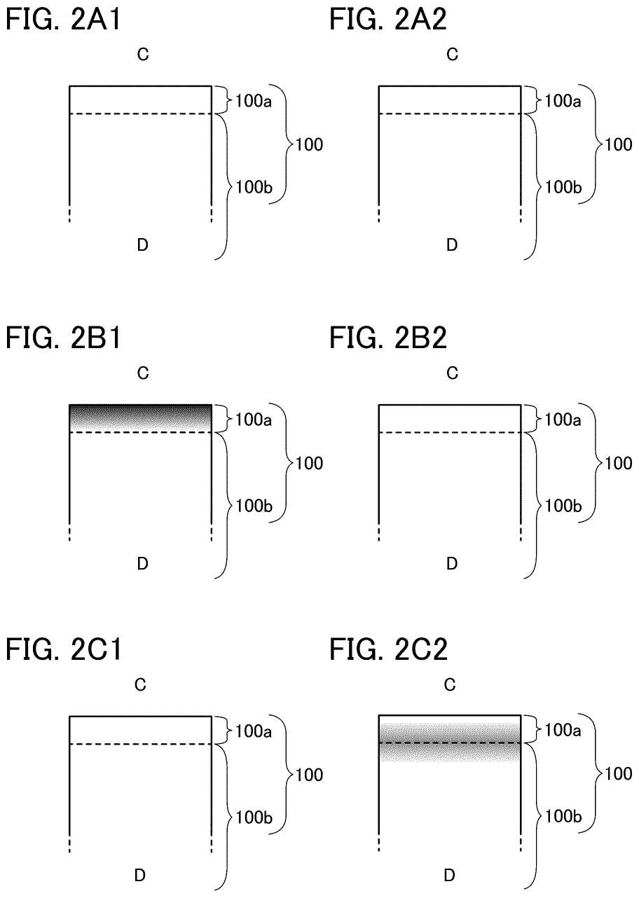

FIG. 1A is a cross-sectional view of a positive electrode active material 100 of one embodiment of the present invention. FIG. 1B, FIG. 1C1, and FIG. 1C2 show enlarged views of a portion near A-B in FIG. 1A. FIG. 2A1, FIG. 2A2, FIG. 2B1, FIG. 2B2, FIG. 2C1, and FIG. 2C2 show enlarged views of a portion near C-D in FIG. 1A. In the gradation in these drawings, the darkness, i.e., being close to black, means a high concentration of a certain element, and the lightness, i.e., being close to white means a low concentration of the element.

As illustrated in FIG. 1A, FIG. 1B, FIG. 1C1, and FIG. 1C2, the positive electrode active material 100 includes a surface portion 100a and an inner portion 100b. In each drawing, the dashed line denotes a boundary between the surface portion 100a and the inner portion 100b. In FIG. 1A, the dashed-dotted line denotes part of a crystal grain boundary.

In this specification and the like, the surface portion 100a of the positive electrode active material 100 or the like refers to a region that is within 50 nm, preferably within 35 nm, further preferably within 20 nm in depth from the surface toward the inner portion, and most preferably a region positioned within 10 nm in depth from the surface toward the inner portion. A plane generated by a split or a crack and an inside of a void generated by a split or a crack may also be referred to as a surface. A region which is deeper than the surface portion 100a is referred to as an inner portion 100b of a particle of an active material or the like. A surface of the positive electrode active material 100 refers to a surface of a composite oxide including the surface portion 100a, the inner portion 100b, and the like. Therefore, the positive electrode active material 100 does not include a carbonic acid, a hydroxy group, or the like which is chemically adsorbed after formation of the positive electrode active material 100. Furthermore, an electrolyte solution, a binder, a conductive material, and a compound originating from any of these that are attached to the positive electrode active material 100 are not included either. The surface of the positive electrode active material 100 in a cross-sectional STEM image or the like refers to a plane in which a metal element having a larger atomic number than lithium is first observed. More specifically, the surface of the positive electrode active material 100 refers to a point in which an atomic nucleus of a metal element having a larger atomic number than lithium, that is, a luminance peak in the cross-sectional STEM image or the like first exists.

In this specification and the like, a grain boundary refers to a portion where particles adhere to each other, a portion where crystal orientation changes inside a particle, a portion including many crystal defects, a portion with a disordered crystal structure, or the like. Note that in this specification and the like, crystal defects refer to defects which can be observed in a TEM image and the like, i.e., a structure in which another element enters a crystal, a cavity, and the like. The grain boundary can be regarded as a plane defect. The vicinity of a grain boundary refers to a region positioned within 10 nm from the grain boundary. Note that the grain boundary can be observed by, for example, cross-sectional observation (cross-sectional TEM or cross-sectional STEM) and the like.

In this specification and the like, particles are not necessarily spherical (with a circular cross section). Other examples of the cross-sectional shapes of particles include an ellipse, a rectangle, a trapezoid, a pyramid, a quadrilateral with rounded corners, and an asymmetrical shape, and a particle may have an indefinite shape.

### <Contained Element>

The positive electrode active material 100 contains a first metal M1, a second metal M2, oxygen, and fluorine. The positive electrode active material 100 can be regarded as a composite oxide represented by LiM1O₂ to which M2 and fluorine are added. Note that the composition is not strictly limited to Li:M1:O=1:1:2 as long as the positive electrode active material of one embodiment of the present invention includes a lithium composite oxide represented by LiM1O₂.

As the first metal M1 contained in the positive electrode active material 100, a transition metal that can form, together with lithium, a composite oxide having the layered rock-salt structure belonging to the space group R-3m is preferably used. For example, at least one of manganese, cobalt, and nickel can be used. That is, as the first metal M1 contained in the positive electrode active material 100, cobalt may be used alone, nickel may be used alone, cobalt and manganese may be used, cobalt and nickel may be used, or cobalt, manganese, and nickel may be used. In other words, the positive electrode active material 100 can contain a composite oxide containing lithium and the first metal M1, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

Note that in this specification and the like, a layered rock-salt crystal structure of a composite oxide containing lithium and a transition metal refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may partly exist. In the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

Using cobalt at greater than or equal to 75 atomic %, preferably greater than or equal to 90 atomic %, further preferably greater than or equal to 95 atomic % as the transition metal contained in the positive electrode active material brings many advantages such as relatively easy synthesis, easy handling, and excellent cycle performance.

When nickel is contained as part of the first metal M1 in addition to cobalt, a shift in a layered structure formed of octahedrons of cobalt and oxygen is sometimes inhibited. This is preferable because the crystal structure becomes more stable particularly in a charged state at a high temperature in some cases. This is probably because nickel is easily diffused into the inside of lithium cobalt oxide, and can be located in lithium sites due to cation mixing at charging while existing in cobalt sites at discharging. Nickel existing in lithium sites at charging functions as a column that supports the layered structure formed of octahedrons of cobalt and oxygen, and contributes to stabilization of the crystal structure.

Note that manganese is not necessarily contained as the first metal M1. In addition, nickel is not necessarily contained.

As the second metal M2 contained in the positive electrode active material 100, at least one of magnesium, aluminum, titanium, zirconium, vanadium, iron, chromium, niobium, lanthanum, yttrium, hafnium, and zinc is preferably used. Silicon, sulfur, phosphorus, boron, or arsenic may be added together with the second metal M2. In particular, addition of phosphorus is preferable because the continuous charge tolerance can be improved and thus a highly safe secondary battery can be provided.

The second metal and fluorine further stabilize a crystal structure included in the positive electrode active material 100 in some cases, as described later. The positive electrode active material 100 can contain lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the second metal M2 may be rephrased as an additive, a mixture, a constituent of a material, an impurity, or the like.

In some cases, manganese, titanium, vanadium, and chromium are likely to have a valence of four stably and thus contribute highly to a stable structure.

The second metal M2 is preferably added at a concentration that does not largely change the crystallinity of the composite oxide represented by LiM1O₂. For example, a preferred addition amount of the second metal M2 is an amount which does not cause the Jahn-Teller effect described later.

Note that aluminum, titanium, zirconium, vanadium, iron, chromium, niobium, lanthanum, yttrium, hafnium, or zinc is not necessarily contained as the second metal.

### <Element Distribution>

The surface portion 100a preferably has higher concentrations of the second metal M2 and fluorine than the inner portion 100b. The second metal M2 and fluorine each preferably have a concentration gradient. In the case where a plurality of elements are used as the second metal M2, the peak positions of the concentrations of the elements are preferably different. It can be said that the second metal M2 and fluorine are unevenly distributed in the surface portion 100a.

For example, a second metal M2(1) preferably has a concentration gradient as illustrated by gradation in FIG. 1C1, in which the concentration increases from the inner portion 100b toward the surface. Examples of the second metal M2(1) that preferably has such a concentration gradient include magnesium, titanium, and the like.

Fluorine also preferably has a concentration gradient as illustrated by the gradation in FIG. 1C1, in which the concentration increases from the inner portion 100b toward the surface.

Preferably, another second metal M2(2) has a concentration gradient as illustrated by gradation in FIG. 1C2 and exhibits a concentration peak at a deeper region than the concentration peak of the second metal M2(1). The concentration peak may be located in the surface portion 100a or located deeper than the surface portion 100a. For example, the concentration peak is preferably located in a region that is 5 nm to 30 nm inclusive in depth from the surface. Examples of the second metal M2(2) that preferably has such a concentration gradient include aluminum and manganese.

It is preferable that the crystal structure continuously change from the inner portion 100b toward the surface portion 100a owing to the above-described concentration gradients of the second metal M2 and fluorine. For example, from a layered rock-salt crystal structure included in the inner portion 100b toward the surface portion 100a, a feature of the rock-salt crystal structure is preferably more distinguishable. Furthermore, it is preferable that the surface portion 100a and the inner portion 100b have substantially the same crystal orientation.

In order to prevent breakage of a layered structure formed of octahedrons of the first metal M1 and oxygen even when lithium is extracted from the positive electrode active material 100 of one embodiment of the present invention owing to charging, the positive electrode active material 100 is reinforced with the surface portion 100a having high concentrations of the second metal M2 and fluorine, i.e., the outer portion of the particle.

The concentration gradient of the second metal M2 preferably exists homogeneously in the surface portion 100a of the positive electrode active material 100. When the concentration gradient of the second metal M2 exists homogeneously in the surface portion 100a of the positive electrode active material 100, stress concentration that can occur locally in a particle can be inhibited. For example, in the case where the concentration gradient of the second metal M2 does not exist homogeneously in the surface portion 100a, stress might concentrate on a particle from a region with no concentration gradient of the second metal M2. The concentration of stress on part of a particle might cause defects such as cracks from that part, leading to breakage of the particle and a decrease in charge and discharge capacity.

Note that not all the second metals M2 necessarily have homogeneous concentration gradients throughout the surface portion 100a of the positive electrode active material 100. FIG. 2A1, FIG. 2B1, and FIG. 2C1 illustrate examples of distribution of the second metal M2(1) in the vicinity of C-D in FIG. 1A. FIG. 2A2, FIG. 2B2, and FIG. 2C2 illustrate examples of distribution of the second metal M2(2) in the vicinity of C-D in FIG. 1A.

The surface portion 100a of the positive electrode active material 100 may have a region including neither the second metal M2(1) nor the second metal M2(2) as illustrated in FIG. 2A1 and FIG. 2A2. There may be a region including the second metal M2(1) but not including the second metal M2(2) as illustrated in FIG. 2B1 and FIG. 2B2. Furthermore, there may be a region including the second metal M2(2) but not including the second metal M2(1) as illustrated in FIG. 2C1 and FIG. 2C2.

Note that in the case where cobalt and nickel are used as the first metal M1, cobalt and nickel are preferably dissolved uniformly in the positive electrode active material 100. In the case where the concentration of a kind of the first metal M1, e.g., nickel, is low, the concentration is sometimes lower than or equal to the detection limit of the analysis of XPS, EDX, or the like.

When the atomic number of nickel is less than the atomic number of cobalt by 2% or more, nickel in a lithium composite oxide accounts for lower than or equal to 0.5 atomic %. The detection limit of XPS and EDX is approximately 1 atomic %. In that case, when nickel is dissolved uniformly in the entire positive electrode active material 100, the concentration can be below the detection limit of the analyzing method such as XPS or EDX. In this case, the concentration below the detection limit indicate that the nickel concentration is lower than or equal to 1 atomic % or that nickel is dissolved in the entire positive electrode active material 100.

Using ICP-MS, GD-MS, or the like, nickel can be quantified even when the nickel concentration is lower than or equal to 1 atomic %.

Note that a kind of the first metal M1, e.g., manganese, included in the positive electrode active material 100 may have a concentration gradient in which the concentration increases from the inner portion 100b to the surface.

As described above, the surface portion 100a of the positive electrode active material 100 of one embodiment of the present invention preferably has a composition different from that in the inner portion 100b, i.e., the concentrations of the second metal M2 and fluorine are preferably higher than those in the inner portion 100b. The surface portion 100a having such a composition preferably has a crystal structure stable at room temperature (25° C.). Accordingly, the surface portion 100a may have a crystal structure different from that of the inner portion 100b. For example, at least part of the surface portion 100a of the positive electrode active material 100 of one embodiment of the present invention may have a rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal have a cubic close-packed structure (face-centered cubic lattice structure).

Note that in this specification and the like, a structure where three layers of anions are shifted and stacked like “ABCABC” is referred to as a cubic close-packed structure. Accordingly, anions do not necessarily form a cubic lattice structure. At the same time, actual crystals always have a defect and thus, analysis results are not necessarily consistent with the theory. For example, in electron diffraction or fast Fourier transform (FFT) of a TEM image or the like, a spot may appear in a position slightly different from a theoretical position. For example, anions may be regarded as forming a cubic close-packed structure when a difference in orientation from a theoretical position is 5 degrees or less or 2.5 degrees or less.

When a layered rock-salt crystal and a rock-salt crystal are in contact with each other, there is a crystal plane at which orientations of cubic close-packed structures composed of anions are aligned with each other.

The description can also be made as follows. Anions on the (111) plane of a cubic crystal structure has a triangle lattice. A layered rock-salt structure, which belongs to a space group R-3m and is a rhombohedral structure, is generally represented by a composite hexagonal lattice for easy understanding of the structure, and the (0001) plane of the layered rock-salt structure has a hexagonal lattice. The triangular lattice on the (111) plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other.”

Note that a space group of the layered rock-salt crystal is R-3m, which is different from the space group Fm-3m of a rock-salt crystal (a space group of a general rock-salt crystal) and the space group Fd-3m of a rock-salt crystal; thus, the Miller index of the crystal plane satisfying the above conditions in the layered rock-salt crystal is different from that in the rock-salt crystal. In this specification, a state where the orientations of the cubic close-packed structures composed of anions in the layered rock-salt crystal and the rock-salt crystal are aligned with each other is referred to as a state where crystal orientations are substantially aligned with each other in some cases.

The orientations of crystals in two regions being substantially aligned with each other can be judged, for example, from a TEM (Transmission Electron Microscope) image, a STEM (Scanning Transmission Electron microscope) image, a HAADF-STEM (High-angle Annular Dark Field Scanning TEM) image, an ABF-STEM (Annular Bright-Field Scanning Transmission Electron microscopy) image, electron diffraction, and FFT of a TEM image or the like. XRD (X-ray Diffraction), neutron diffraction, and the like can also be used for judging.

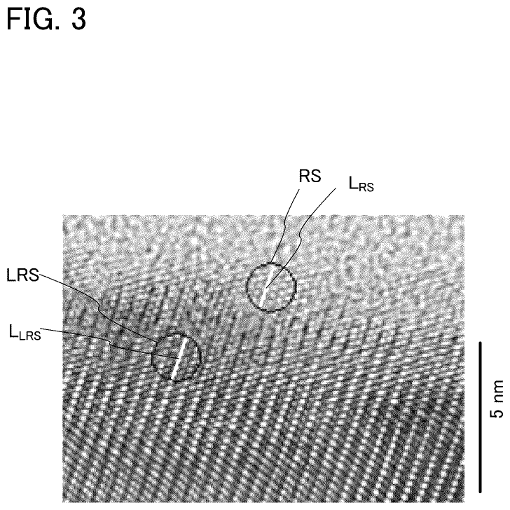

FIG. 3 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 3) is 5 degrees or less or 2.5 degrees or less in the TEM image, it can be judged that the crystal planes are substantially aligned with each other, that is, orientations of the crystals are substantially aligned with each other. Similarly, when the angle between the dark lines is 5 degrees or less or 2.5 degrees or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having the layered rock-salt crystal structure is observed in a direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5 degrees or less or 2.5 degrees or less in a HAADF-STEM image, it can be judged that arrangements of the atoms are substantially aligned with each other, that is, orientations of the crystals are substantially aligned with each other. Similarly, when the angle between the dark lines is 5 degrees or less or 2.5 degrees or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

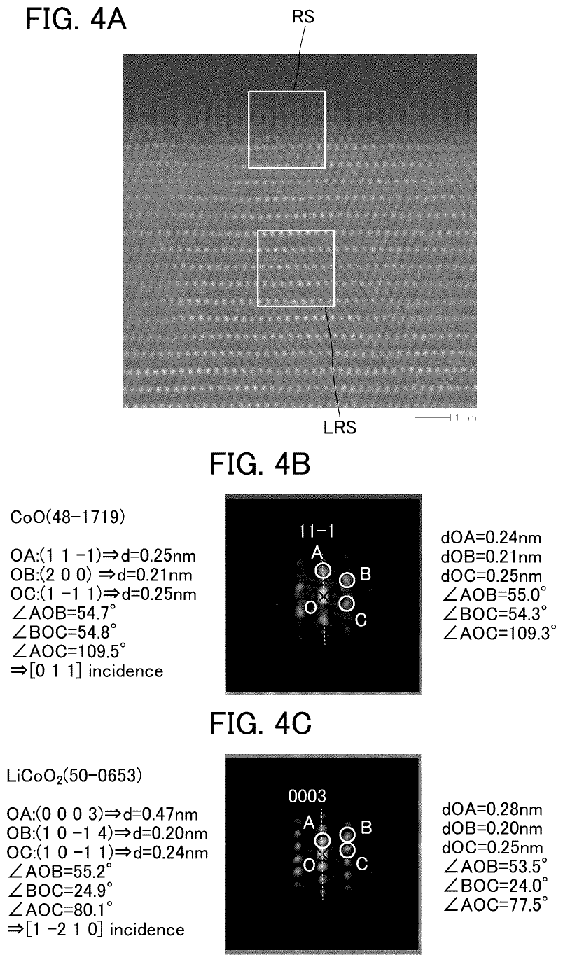

FIG. 4A shows an example of a STEM image in which orientations of the layered rock-salt crystal LRS and the rock-salt crystal RS are substantially aligned with each other. FIG. 4B shows FFT of a region of the rock-salt crystal RS, and FIG. 4C shows FFT of a region of the layered rock-salt crystal LRS. In FIG. 4B and FIG. 4C, the composition, the JCPDS card number, and d values and angles to be calculated are shown on the left. The measured values are shown on the right. A spot denoted by O is zero-order diffraction.

A spot denoted by A in FIG. 4B is derived from 11-1 reflection of a cubic structure. A spot denoted by A in FIG. 4C is derived from 0003 reflection of a layered rock-salt structure. It is found from FIG. 4B and FIG. 4C that the direction of the 11-1 reflection of the cubic structure and the direction of the 0003 reflection of the layered rock-salt structure are substantially aligned with each other. That is, a straight line that passes through AO in FIG. 4B is substantially parallel to a straight line that passes through AO in FIG. 4C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in FFT and electron diffraction, the <0003> orientation of the layered rock-salt crystal and the <11-1> orientation of the rock-salt crystal may be substantially aligned with each other. In that case, it is preferred that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 4C is derived from 1014 reflection of the layered rock-salt structure. This is sometimes observed at a position where the difference in orientation from the reciprocal lattice point derived from the 0003 reflection of the layered rock-salt structure (A in FIG. 4C) is greater than or equal to 52° and less than or equal to 56° (i.e., ∠AOB is 52° to 56°) and d is greater than or equal to 0.19 nm and less than or equal to 0.21 nm. Note that these indices are just examples, and the spot does not necessarily correspond with them. For example, the spot may be a reciprocal lattice point equivalent to the indices.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 4B is derived from 200 reflection of the cubic structure. The spot derived from 200 reflection of the cubic structure is sometimes observed at a position where the difference in orientation from the reciprocal lattice point derived from the 11-1 reflection of the cubic structure (A in FIG. 4B) is greater than or equal to 54° and less than or equal to 56° (i.e., ∠AOB is 54° to 56°). Note that these indices are just examples, and the spot does not necessarily correspond with them. For example, the spot may be a surface equivalent to the indices.

It is known that in a layered rock-salt positive electrode active material, such as lithium cobalt oxide, the (0003) plane and a plane equivalent thereto and the (10-14) plane and a plane equivalent thereto are likely to be crystal planes. Thus, a sample to be observed can be processed to be thin using a focused ion beam (FIB) or the like such that an electron beam of a TEM, for example, enters in [12-10], in order to easily observe the (0003) plane in careful observation of the shape of the positive electrode active material with a SEM or the like. To judge alignment of crystal orientations, a sample is preferably processed to be thin so that the (0003) plane of the layered rock-salt structure is easily observed.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

### <Internal Crystal Structure>

A material with a layered rock-salt crystal structure, such as lithium cobalt oxide (LiCoO₂), is known to have a high discharge capacity and excel as a positive electrode active material of a secondary battery.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with high voltage are performed on LiNiO₂, the crystal structure might be broken because of the distortion. The influence of the Jahn-Teller effect is suggested to be small in LiCoO₂; hence, LiCoO₂ is preferable because the tolerance at the time of high voltage charging is higher in some cases.

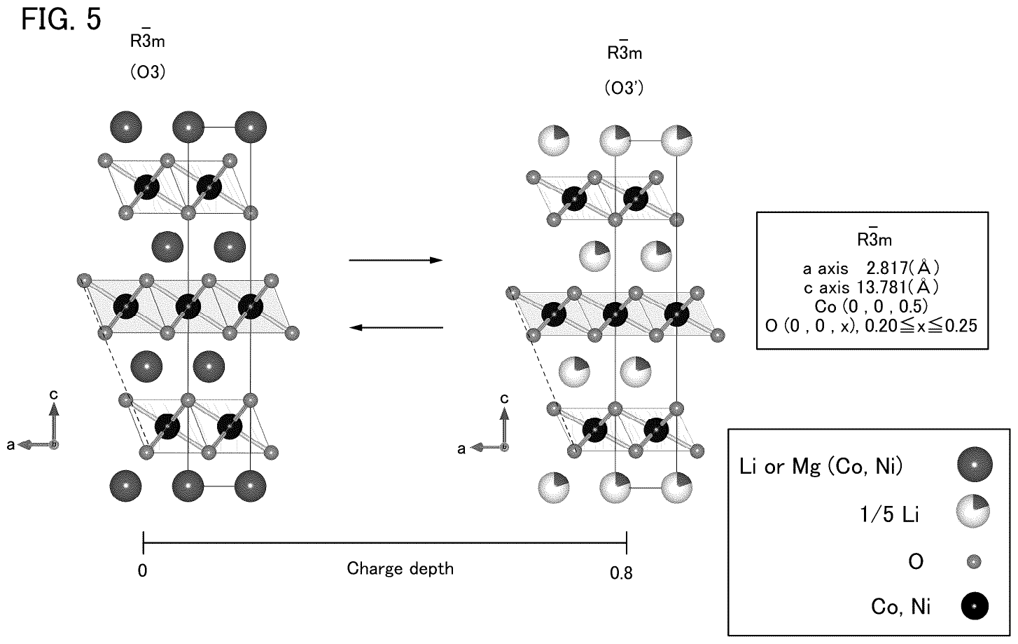

Positive electrode active materials are described with reference to FIG. 5 to FIG. 8. In FIG. 5 to FIG. 8, the case where cobalt is used as the first metal M1 contained in the positive electrode active material is described.

### <<Conventional Positive Electrode Active Material>>

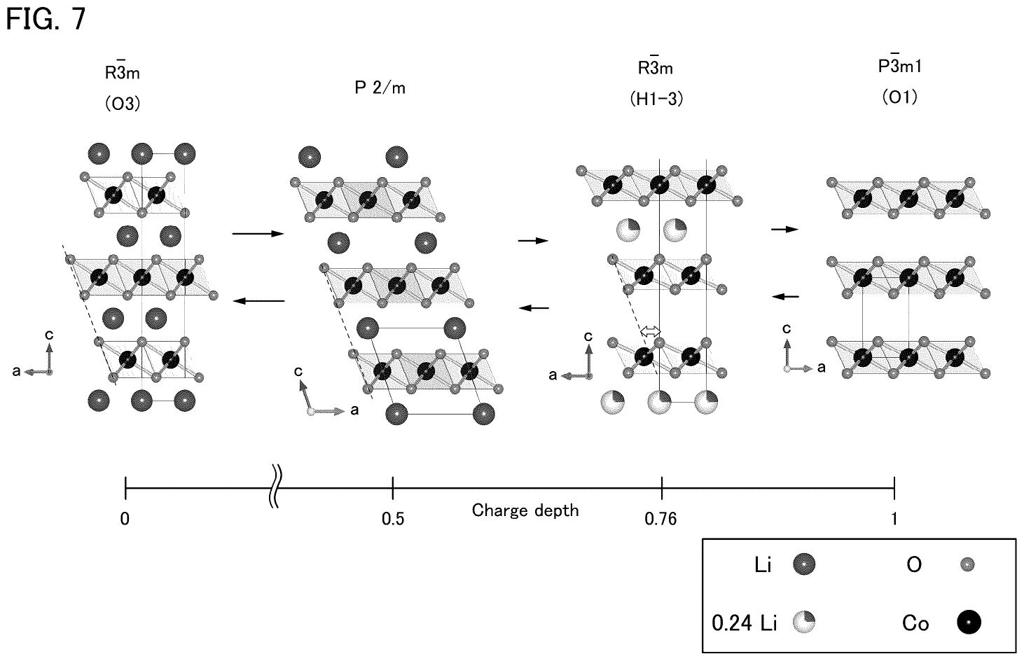

A positive electrode active material shown in FIG. 7 is lithium cobalt oxide (LiCoO₂) to which fluorine and magnesium are not added in a formation method described later. As described in Non-Patent Documents 1 and 2 and the like, the crystal structure of the lithium cobalt oxide shown in FIG. 7 changes with the charge depth.

As shown in FIG. 7, in lithium cobalt oxide with a charge depth of 0 (discharged state), there is a region having a crystal structure belonging to the space group R-3m, and a unit cell includes three CoO₂ layers. Thus, this crystal structure is referred to as an O3 type crystal structure in some cases. Note that here, the CoO₂ layer has a structure in which an octahedral structure with cobalt coordinated to six oxygen atoms continues on a plane in an edge-shared state.

Lithium cobalt oxide with a charge depth of 1 has the crystal structure belonging to the space group P-3m1 and includes one CoO₂ layer in a unit cell. Hence, this crystal structure is referred to as an O1 type crystal structure in some cases.

Lithium cobalt oxide with a charge depth of approximately 0.76 has the crystal structure belonging to the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification, FIG. 7, and other drawings, the c-axis of the H1-3 type crystal structure is half that of the unit cell for easy comparison with the other structures.

For the H1-3 type crystal structure, as disclosed in Non-Patent Document 3, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). Note that O₁ and O₂ are each an oxygen atom. In this manner, the H1-3 type crystal structure is represented by a unit cell including one cobalt atom and two oxygen atoms. Meanwhile, the O3′ type crystal structure of embodiments of the present invention are preferably represented by a unit cell including one cobalt atom and one oxygen atom, as described later. This means that the symmetry of cobalt and oxygen differs between the O3′ structure and the H1-3 type structure, and the amount of change from the O3 structure is smaller in the O3′ structure than in the H1-3 type structure. A preferred unit cell for representing a crystal structure in a positive electrode active material can be selected by Rietveld analysis of XRD, for example. In this case, a unit cell is selected such that the value of GOF (goodness of fit) is small.

When charging at a high charge voltage of 4.6 V or more with reference to the redox potential of a lithium metal or charging with a large charge depth of 0.8 or more and discharging are repeated, the crystal structure of lithium cobalt oxide changes (i.e., an unbalanced phase change occurs) repeatedly between the H1-3 type crystal structure and the structure belonging to R-3m (O3) in a discharged state.

However, there is a large shift in the CoO₂ layers between these two crystal structures. As denoted by the dotted lines and the arrow in FIG. 7, the CoO₂ layer in the H1-3 type crystal structure largely shifts from R-3m (O3). Such a dynamic structural change can adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are arranged continuously, such as P-3m1 (O1), included in the H1-3 type crystal structure is highly likely to be unstable.

Accordingly, the repeated charging and discharging with high voltage gradually break the crystal structure of lithium cobalt oxide. The broken crystal structure triggers deterioration of the cycle performance. This is because the broken crystal structure has a smaller number of sites where lithium can exist stably and makes it difficult to insert and extract lithium.

### <<Positive Electrode Active Material of One Embodiment of the Present Invention>>

In the positive electrode active material 100 of one embodiment of the present invention, the shift in CoO₂ layers can be small in repeated charging and discharging with high voltage.

Furthermore, the change in the volume can be small. Accordingly, the positive electrode active material of one embodiment of the present invention can achieve excellent cycle performance. In addition, the positive electrode active material of one embodiment of the present invention can have a stable crystal structure in a high voltage charged state. Thus, in the positive electrode active material of one embodiment of the present invention, a short circuit is unlikely to occur while the high voltage charged state is maintained, in some cases. This is preferable because the safety is further improved.

The positive electrode active material of one embodiment of the present invention has a small crystal-structure change and a small volume difference per the same number of atoms of the transition metal between a sufficiently discharged state and a state with a large charge depth.

FIG. 5 shows a crystal structure of the positive electrode active material 100 before and after charging and discharging. The positive electrode active material 100 is a composite oxide containing lithium, cobalt as the first metal M1, and oxygen. In addition to the above-described elements, magnesium is preferably contained as the second metal M2. Furthermore, fluorine is preferably contained.

The crystal structure with a charge depth of 0 (in the discharged state) in FIG. 5 is R-3m (O3) as in FIG. 7. Meanwhile, the positive electrode active material 100 has a structure is different from the H1-3 type crystal structure when the charge depth is large. This structure belongs to the space group R-3m and is a structure in which an ion of cobalt, magnesium, or the like occupies a site coordinated to six oxygen atoms. Furthermore, the symmetry of CoO₂ layers of this structure is the same as that in the O3 type structure. This structure is thus referred to as the O3′ type crystal structure in this specification and the like. In both the O3 type crystal structure and the O3′ type crystal structure, a slight amount of magnesium preferably exists between the CoO₂ layers, i.e., in lithium sites. In addition, a slight amount of fluorine preferably exists at random in oxygen sites.

Note that in the O3′ type crystal structure, a light element such as lithium sometimes occupies a site coordinated to four oxygen atoms.

Although a chance of the existence of lithium is the same in all lithium sites in FIG. 5, the positive electrode active material of one embodiment of the present invention is not limited thereto. Lithium may exist unevenly in only some of the lithium sites. For example, lithium may exist in some lithium sites that are aligned, as in Li_{0.5}CoO₂ belonging to the space group P2/m. Distribution of lithium can be analyzed by neutron diffraction, for example.

The O3′ type crystal structure can be regarded as a crystal structure that contains lithium between layers randomly and is similar to a CdCl₂ type crystal structure. The crystal structure similar to the CdCl₂ type crystal structure is close to a crystal structure of lithium nickel oxide (Li_{0.06}NiO₂) charged to a charge depth of 0.94; however, pure lithium cobalt oxide or a layered rock-salt positive electrode active material containing a large amount of cobalt is known not to have such a crystal structure generally.

In the positive electrode active material 100 of one embodiment of the present invention, a change in the crystal structure caused when a large amount of lithium is extracted by charging with high voltage is smaller than that in a conventional positive electrode active material. As denoted by the dotted lines in FIG. 5, for example, the CoO₂ layers hardly shift between the crystal structures.

Specifically, the structure of the positive electrode active material 100 of one embodiment of the present invention is highly stable even when the charge depth is large. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, a H1-3 type crystal is eventually observed in some cases.

Thus, in the positive electrode active material 100 of one embodiment of the present invention, the crystal structure is unlikely to be broken even when charging and discharging with high voltage are repeated.

The space group of a crystal structure is identified by XRD, electron diffraction, neutron diffraction, or the like. Thus, in this specification and the like, being a space group can be rephrased as being identified as a space group.

In the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery which includes graphite as a negative electrode active material and which has a voltage of greater than or equal to 4.3 V and less than or equal to 4.5 V, for example, the positive electrode active material 100 of one embodiment of the present invention can maintain the crystal structure belonging to R-3m (O3) and moreover, can have the O3′ type crystal structure at higher charge voltages, e.g., a voltage of the secondary battery of greater than 4.5 V and less than or equal to 4.6 V. In addition, the positive electrode active material 100 of one embodiment of the present invention can have the O3′ type crystal structure at lower charge voltages, e.g., at a voltage of the secondary battery of greater than or equal to 4.2 V and less than 4.3 V.

Note that in the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811, typically, c=13.781 (Å).

A slight amount of the second metal M2 such as magnesium randomly existing between the CoO₂ layers, i.e., in lithium sites, can suppress a shift in the CoO₂ layers at the time of charging with high voltage. Thus, magnesium between the CoO₂ layers makes it easier to obtain the O3′ type crystal structure. For this reason, magnesium is preferably distributed throughout the positive electrode active material 100 of one embodiment of the present invention (i.e., the surface portion 100a and the inner portion 100b) at an appropriate concentration. To distribute magnesium throughout the whole, heat treatment is preferably performed in the formation process of the positive electrode active material 100 of one embodiment of the present invention.

However, heat treatment at an excessively high temperature may cause cation mixing, which increases the possibility of entry of the second metal M2 such as magnesium into the cobalt sites. Magnesium in the cobalt sites does not have the effect of maintaining the structure belonging to R-3m at the time of charging with high voltage. Furthermore, heat treatment at an excessively high temperature might have an adverse effect; for example, cobalt might be reduced to have a valence of two or lithium might be evaporated.

In view of the above, a fluorine compound such as a halogen compound is preferably added to lithium cobalt oxide before the heat treatment for distributing magnesium throughout the whole. The addition of the halogen compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. Moreover, an undesired magnesium compound (e.g., an oxide or a fluoride) which does not enter the lithium site or the cobalt site might be unevenly distributed at the surface of the positive electrode active material to serve as a resistance component. The number of magnesium atoms in the positive electrode active material of one embodiment of the present invention is preferably greater than or equal to 0.001 times and less than or equal to 0.1 times, further preferably greater than 0.01 times and less than 0.04 times, still further preferably approximately 0.02 times the number of atoms of the first metal M1. Alternatively, it is preferably greater than or equal to 0.001 times and less than 0.04 times. Alternatively, it is preferably greater than or equal to 0.01 times and less than or equal to 0.1 times. The magnesium concentration described here may be a value obtained by element analysis on the whole of the positive electrode active material using ICP-MS or the like, or may be a value based on the ratio of the raw materials mixed in the process of forming the positive electrode active material, for example.

As shown in introductory remarks in FIG. 5, nickel preferably exists in cobalt sites, but part of them may exist in lithium sites. Magnesium preferably exists in lithium sites. Fluorine may be substituted for part of oxygen.

As the magnesium concentration in the positive electrode active material 100 of one embodiment of the present invention increases, the charge and discharge capacity of the positive electrode active material 100 decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material 100 of one embodiment of the present invention contains nickel, the charge and discharge capacity per weight and per volume can be increased in some cases. When the positive electrode active material 100 of one embodiment of the present invention contains aluminum, the charge and discharge capacity per weight and per volume can be increased in some cases. When the positive electrode active material 100 of one embodiment of the present invention contains nickel and aluminum, the charge and discharge capacity per weight and per volume can be increased in some cases.

The concentrations of the nickel and aluminum elements contained in the positive electrode active material of one embodiment of the present invention are described below using the number of atoms.

When the number of cobalt atoms is regarded as 100%, the number of nickel atoms in the positive electrode active material of one embodiment of the present invention is preferably higher than 0% and lower than or equal to 7.5%, preferably higher than or equal to 0.05% and lower than or equal to 4%, further preferably higher than or equal to 0.1% and lower than or equal to 2% of the number of cobalt atoms. Alternatively, it is preferably higher than 0% and lower than or equal to 4%. Alternatively, it is preferably higher than 0% and lower than or equal to 2%. Alternatively, it is preferably higher than or equal to 0.05% and lower than or equal to 7.5%. Alternatively, it is preferably higher than or equal to 0.05% and lower than or equal to 2%. Alternatively, it is preferably higher than or equal to 0.1% and lower than or equal to 7.5%. Alternatively, it is preferably higher than or equal to 0.1% and lower than or equal to 4%. The nickel concentration described here may be a value obtained by element analysis on the entire particle of the positive electrode active material using ICP-MS or the like, or may be a value based on the ratio of the raw materials mixed in the forming process of the positive electrode active material, for example.

When the number of cobalt atoms is regarded as 100%, the number of aluminum atoms in the positive electrode active material of one embodiment of the present invention is preferably higher than or equal to 0.05% and lower than or equal to 4%, further preferably higher than or equal to 0.1% and lower than or equal to 2% of the number of cobalt atoms. Alternatively, it is preferably higher than or equal to 0.05% and lower than or equal to 2%. Alternatively, it is preferably higher than or equal to 0.1% and lower than or equal to 4%. The aluminum concentration described here may be a value obtained by element analysis on the entire particle of the positive electrode active material using ICP-MS or the like, or may be a value based on the ratio of the raw materials mixed in the forming process of the positive electrode active material, for example.

Magnesium is preferably distributed throughout the positive electrode active material 100 of one embodiment of the present invention (i.e., the surface portion 100a and the inner portion 100b), and in addition to this, the concentrations of the second metal M2 and fluorine in the surface portion 100a are preferably higher than the average in the whole particle as described above. More specifically, the concentrations of the second metal M2 and fluorine in the surface portion 100a measured by XPS or the like are preferably higher than the average concentrations of the second metal M2 and fluorine in the whole particle measured by ICP-MS or the like.

It is more preferable that part of the second metal M2 and part of fluorine included in the positive electrode active material 100 of one embodiment of the present invention be distributed unevenly at a crystal grain boundary 101 as illustrated in FIG. 1A.

In other words, the concentrations of the second metal M2 and fluorine at the crystal grain boundary 101 and the vicinity thereof in the positive electrode active material 100 of one embodiment of the present invention are preferably higher than those in the other regions in the inner portion.

The crystal grain boundary 101 is a plane defect, and thus tends to be unstable and suffer a change in the crystal structure like the surface of the particle. Thus, the higher the concentrations of the second metal M2 and fluorine at the crystal grain boundary 101 and the vicinity thereof are, the more effectively the change in the crystal structure can be reduced.

When the concentrations of the second metal M2 and fluorine are high at the crystal grain boundary and the vicinity thereof, the concentrations of the second metal M2 and fluorine in the vicinity of a surface generated by a crack 102 are also high even when the crack 102 is generated along the crystal grain boundary 101 of the particle of the positive electrode active material 100 of one embodiment of the present invention. Thus, the positive electrode active material can have an increased corrosion resistance to hydrofluoric acid even after the crack 102 is generated.

Note that in this specification and the like, the vicinity of the crystal grain boundary 101 refers to a region of approximately 10 nm from the grain boundary.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as difficulty in loading of the active material layer at the time when the material is applied to the current collector and overreaction with the electrolyte solution. Therefore, the average particle diameter (D50, also referred to as a median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the median diameter (D50) is preferably greater than or equal to 1 μm and less than or equal to 40 μm, greater than or equal to 1 μm and less than or equal to 30 μm, greater than or equal to 2 μm and less than or equal to 100 μm, greater than or equal to 2 μm and less than or equal to 30 μm, greater than or equal to 5 μm and less than or equal to 100 μm, or greater than or equal to 5 μm and less than or equal to 40 μm.

Alternatively, the positive electrode active materials 100 having two or more different particle diameters may be mixed and used. In other words, the positive electrode active materials which have a plurality of peaks when the particle size distribution is measured by a laser diffraction and scattering method may be used. At this time, the mixing ratio is preferably set such that the powder packing density becomes large, in which case the capacity per volume of the secondary battery can be improved.

### <Analysis Method>

Whether or not a given positive electrode active material is the positive electrode active material 100 of one embodiment of the present invention, which has the O3′ type crystal structure when the charge depth is large, can be judged by analyzing a positive electrode including the positive electrode active material with a large charge depth by XRD, electron diffraction, neutron diffraction, electron spin resonance (ESR), nuclear magnetic resonance (NMR), or the like. XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example.

As described so far, the positive electrode active material 100 of one embodiment of the present invention has a feature of a small change in the crystal structure between a state with a large charge depth and a discharged state. A material where 50 wt % or more of the crystal structure largely changes between the high-voltage charged state and the discharged state is not preferable because the material cannot withstand the high-voltage charging and discharging. It should be noted that the intended crystal structure is not obtained in some cases only by addition of the second metal M2 and fluorine. For example, in a high voltage charged state, some lithium cobalt oxides containing magnesium and fluorine have an area intensity I_{H1-3} of H1-3 type exceeding 60% and other lithium cobalt oxides containing magnesium and fluorine have an area intensity I_{H1-3} not exceeding 60%. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD or other methods.

However, the crystal structure of a positive electrode active material in a high voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charging Method>>

High-voltage charging for determining whether or not a composite oxide is the positive electrode active material 100 of one embodiment of the present invention can be performed on a coin cell (CR2032 type with a diameter of 20 mm and a height of 3.2 mm) using lithium for a negative electrode, for example.

More specifically, a positive electrode can be formed by application of a slurry in which the positive electrode active material, a conductive additive, and a binder are mixed to a positive electrode current collector made of aluminum foil.

A lithium metal can be used for a negative electrode. Note that when the negative electrode is formed using a material other than the lithium metal, the voltage of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated under the above conditions is subjected to constant current charging at 4.6 V and 0.5 C and then to constant voltage charging until the current value reaches 0.01 C. Note that here, 1 C is 137 mA/g. Thus, when the amount of a positive electrode active material per coin cell is 10 mg, the charging corresponds to 0.685 mA. To observe a phase change of the positive electrode active material, charge with such a small current value is preferably performed. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode enclosed in an airtight container for XRD measurement with an argon atmosphere. After charge is completed, the positive electrode is preferably taken out immediately and subjected to the analysis. Specifically, the positive electrode is preferably subjected to the analysis within an hour after the completion of charge, further preferably within 30 minutes after the completion of charge.

The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

Constant current charging refers to a charging method with a fixed charge rate, for example. Constant voltage charging refers to a charging method in which voltage is fixed when reaching the upper voltage limit, for example. Constant current discharging refers to a discharging method with a fixed discharge rate, for example.

### <<XRD>>

The apparatus and conditions adopted in the XRD measurement are not particularly limited. The measurement can be performed with the apparatus and conditions as described below, for example.
XRD apparatus: D8 ADVANCE produced by Bruker AXS
X-ray source: CuKα radiation
Output: 40 KV, 40 mA
Slit system: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

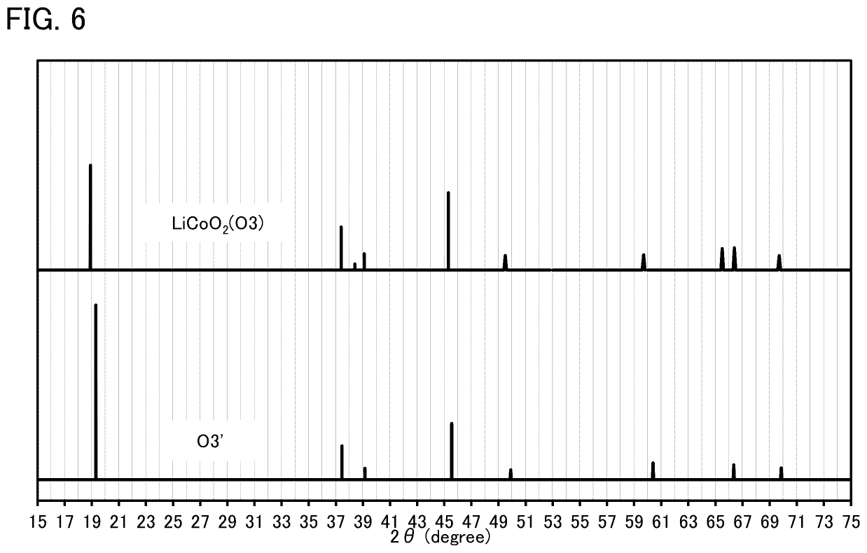

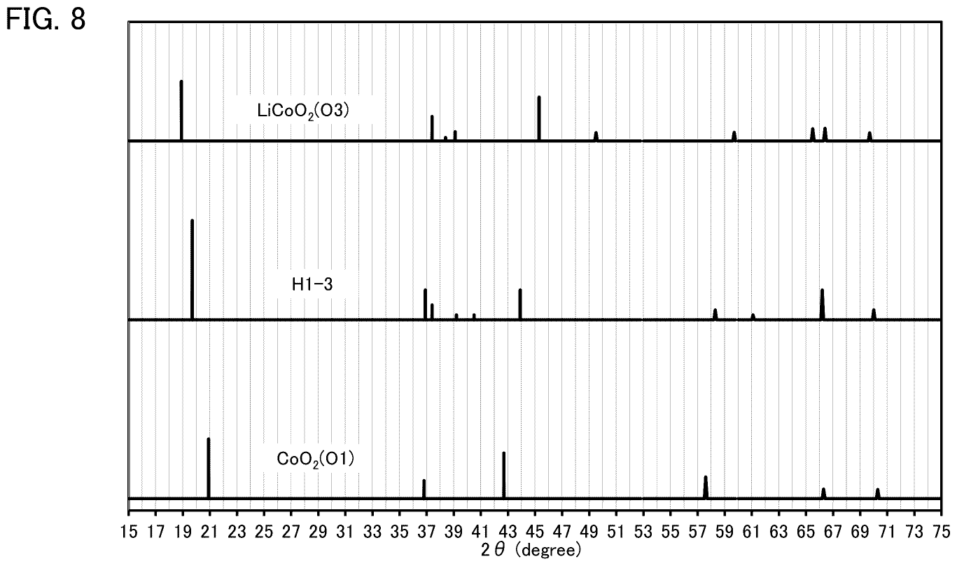

FIG. 6 and FIG. 8 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with a charge depth of 0 and the crystal structure of CoO₂ (O1) with a charge depth of 1 are also shown. Note that the patterns of LiCoO₂ (O3) and CoO₂ (O1) were made from crystal structure data obtained from the Inorganic Crystal Structure Database (ICSD) (see Non-Patent Document 5) with Reflex Powder Diffraction, which is a module of Materials Studio (BIOVIA). The range of 2θ was from 15° to 75°, the step size was 0.01, the wavelength λ1 was 1.540562×10⁻¹⁰ m, the wavelength λ2 was not set, and a single monochromator was used. The pattern of the H1-3 type crystal structure was similarly made from the crystal structure data disclosed in Non-Patent Document 3. The O3′ type crystal structure was estimated from the XRD pattern of the positive electrode active material of one embodiment of the present invention, the crystal structure was fitted with TOPAS Version 3 (crystal structure analysis software produced by Bruker AXS), and the XRD pattern of the O3′ type crystal structure was made in a similar manner to O3, O1, H1-3.

As shown in FIG. 6, the O3′ type crystal structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, the O3′ type crystal structure exhibits sharp diffraction peaks at 2θ of 19.30±0.10° (greater than or equal to 19.20° and less than or equal to 19.40°) and 2θ of 45.55±0.05° (greater than or equal to 45.50° and less than or equal to 45.60°). By contrast, as shown in FIG. 8, the H1-3 type crystal structure and CoO₂ (P-3m1, O1) do not exhibit peaks at these positions. Thus, the peaks at 2θ of 19.30±0.20° and 2θ of 45.55±0.10° in a high voltage charged state can be the features of the positive electrode active material 100 of one embodiment of the present invention.

It can be said that the positions of the XRD diffraction peaks exhibited by the crystal structure with a charge depth of 0 are close to those of the XRD diffraction peaks exhibited by the crystal structure at the time of high voltage charging. More specifically, it can be said that a difference in the positions of two or more, preferably three or more of the main diffraction peaks between the crystal structures is 2θ=0.7° or less, preferably 2θ=0.5° or less.

Sharpness of a diffraction peak in an XRD pattern indicates the degree of crystallinity. It is thus preferable that the diffraction peaks after charge be sharp, in other words, have a small half width. Even peaks that are derived from the same crystal phase have different half widths depending on the XRD measurement conditions and/or the 2θ value. In the case of the above-described measurement conditions, the peak observed at 2θ of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity efficiently contributes to stability of the crystal structure after charge.

Although the positive electrode active material 100 of one embodiment of the present invention has the O3′ type crystal structure at the time of high voltage charging, not all the particles necessarily have the O3′ type crystal structure. Some of the particles may have another crystal structure or be amorphous.

For example, when the area intensity ratios of the H1-3 type peak and the O3′ type peak are compared in the XRD patterns at the charge of 4.6 V, the ratio of the area intensity of the H1-3 type may be lower than or equal to a certain value. Alternatively, the area intensity ratio of the H1-3 type peak and the area intensity ratios of the O3′ type peak and the O3 type peak may be higher than or equal to a certain value.

For example, in the H1-3 type structure, a peak corresponding to the (006) plane is observed at 2θ=19.69°±0.2°. In addition, in the O3′ type structure and O3 type structure of LiCoO₂, a peak corresponding to the (003) plane is observed at 2θ=19.30±0.20°. Accordingly, in a range where 2θ is greater than or equal to 18° and less than or equal to 20°, the area intensity at 2θ=19.30° or smaller can be regarded as the area intensity of the O3′ type peak and the O3 type peak. The area intensity ratio I_{H1-3(006)}/I_{O3′+O3(003)} is preferably less than or equal to 60%, further preferably less than or equal to 50%, and still further preferably less than or equal to 40%. With such an area intensity ratio, the positive electrode active material can have sufficiently high charge and discharge cycle performance.

Also in the H1-3 type structure, a peak corresponding to the (107) plane is observed at 2θ=43.83°±0.2°. In the O3′ type structure and the O3 type structure, a peak corresponding to the (104) plane is observed at 2θ=45.55°±0.2°. Accordingly, in a range where 2θ is greater than or equal to 43° and less than or equal to 46°, the area intensity at 2θ=44.50° or higher can be regarded as the area intensity of the O3′ type peak and the O3 type peak. The area intensity ratio I_{H1-3(106)}/I_{O3′+O3(104)} is preferably less than or equal to 50%, further preferably less than or equal to 40%, and still further preferably less than or equal to 30%. With such an area intensity ratio, the positive electrode active material can have sufficiently high charge and discharge cycle performance.

Note that a peak with 2θ of greater than or equal to 43° and less than or equal to 46° is likely to be broad; however, a peak with 2θ of greater than or equal to 18° and less than or equal to 20 is relatively sharp, whereby for analyzing the area intensity ratio, the peak with 2θ of greater than or equal to 18° and less than or equal to 20 is preferably used.

As described above, the influence of the Jahn-Teller effect is preferably small in the positive electrode active material 100 of one embodiment of the present invention. It is preferable that the positive electrode active material 100 of one embodiment of the present invention have a layered rock-salt crystal structure and mainly contain cobalt as a transition metal. The positive electrode active material 100 of one embodiment of the present invention may contain the above-described second metal M2, nickel, and manganese in addition to cobalt as long as the influence of the Jahn-Teller effect is small.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a can be analyzed by electron diffraction of a cross section of the positive electrode active material 100, for example.

### <<XPS>>

A region that is approximately 2 nm to 8 nm (normally, approximately 5 nm) in depth from a surface can be analyzed by X-ray photoelectron spectroscopy (XPS); thus, the concentrations of elements in approximately half the depth of the surface portion 100a can be quantitatively analyzed. The bonding states of the elements can be analyzed by narrow scanning. Note that the quantitative accuracy of XPS is approximately ±1 atomic % in many cases. The lower detection limit is approximately 1 atomic % but depends on the element.

When the positive electrode active material 100 of one embodiment of the present invention is subjected to XPS analysis, the number of atoms of the second metal M2 is preferably greater than or equal to 1.6 times and less than or equal to 6.0 times, further preferably greater than or equal to 1.8 times and less than 4.0 times the number of atoms of the first metal M1. When the second metal M2 is magnesium and the first metal M1 is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of a halogen such as fluorine is preferably greater than or equal to 0.2 times and less than or equal to 6.0 times, further preferably greater than or equal to 1.2 times and less than or equal to 4.0 times the number of atoms of the first metal M1.

In the XPS analysis, monochromatic aluminum can be used as an X-ray source, for example. An extraction angle is, for example, 45°. For example, the measurement can be performed using the following apparatus and conditions.
Measurement device: Quantera II produced by PHI, Inc.
X-ray source: monochromatic Al Kα (1486.6 eV)
Detection area: 100 μmϕ
Detection depth: approximately 4 nm to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentration of the second metal M2 that preferably exists in the surface portion 100a in a large amount, such as magnesium and aluminum, measured by XPS or the like is preferably higher than the concentrations measured by inductively coupled plasma mass spectrometry (ICP-MS), glow discharge mass spectrometry (GD-MS), or the like.

When a cross section [0161] is exposed by processing and analyzed by TEM-EDX, the concentrations of magnesium and aluminum in the surface portion 100a are preferably higher than those in the inner portion 100b. For example, in the TEM-EDX analysis, the magnesium concentration preferably attenuates, at a depth of 1 nm from a point where the magnesium concentration reaches a peak, to less than or equal to 60% of the peak concentration. In addition, the magnesium concentration preferably attenuates, at a depth of 2 nm from the point where the concentration reaches the peak, to less than or equal to 30% of the peak concentration. An FIB (Focused Ion Beam) can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

### <<ESR>>

As described above, the positive electrode active material of one embodiment of the present invention preferably contains cobalt and nickel as the transition metal and magnesium as the second metal M2. It is preferable that Ni³⁺ be substituted for part of Co³⁺ and Mg²⁺ be substituted for part of Li⁺ accordingly. Accompanying the substitution of Mg²⁺ for Li⁺, the Ni³⁺ might be reduced to be Ni²⁺. Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material is preferably higher than or equal to 2.0×10¹⁷ spins/g and less than or equal to 1.0×10²¹ spins/g. The positive electrode active material preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by electron spin resonance (ESR), for example.

### <<EPMA>>

Elements can be quantified by EPMA (electron probe microanalysis). In surface analysis, distribution of each element can be analyzed.

In EPMA, a region from a surface to a depth of approximately 1 μm is analyzed. Thus, the concentration of each element is sometimes different from measurement results obtained by other analysis methods. For example, when surface analysis is performed on the positive electrode active material 100, the concentration of the second metal M2 existing in the surface portion 100a might be lower than the concentration obtained in XPS. The concentration of the second metal M2 existing in the surface portion 100a might be higher than the concentration obtained in ICP-MS or a value based on the ratio of the raw materials mixed in the process of forming the positive electrode active material.

EPMA surface analysis of a cross section of the positive electrode active material 100 of one embodiment of the present invention preferably reveals a concentration gradient in which the concentration of the second metal M2 increases from the inner portion toward the surface portion 100a. Specifically, each of magnesium, fluorine, and titanium preferably has a concentration gradient in which the concentration increases from the inner portion toward the surface as shown in FIG. 1C1. The concentration of aluminum preferably has a peak in a region deeper than the region where the concentration of any of the above elements has a peak, as shown in FIG. 2C2. The aluminum concentration peak may be located in the surface portion 100a or located deeper than the surface portion 100a.

Note that the surface and the surface portion 100a of the positive electrode active material 100 of one embodiment of the present invention do not contain a carbonic acid, a hydroxy group, or the like which is chemisorbed after formation of the positive electrode active material 100. Furthermore, an electrolyte solution, a binder, a conductive material, and a compound originating from any of these that are attached to the surface of the positive electrode active material 100 are not contained either. Thus, in quantification of the elements contained in the positive electrode active material 100, correction may be performed to exclude carbon, hydrogen, excess oxygen, excess fluorine, and the like that might be detected in surface analysis such as XPS and EPMA. For example, in XPS, the kinds of bonds can be identified by analysis, and a C-F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved to a solvent or the like used in the washing at this time, the first metal M1 and the second metal M2 are not easily dissolved even in that case, which does not affect the atomic ratio of the first metal M1 and the second metal M2.

### <<Surface Roughness and Specific Surface Area>>

The positive electrode active material 100 of one embodiment of the present invention preferably has a smooth surface with little unevenness. A smooth surface with little unevenness indicates favorable distribution of the second metal M2 in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image or cross-sectional TEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with a magic hand tool or the like, and data is extracted to spreadsheet software or the like. With the use of the function of the spreadsheet software or the like, correction was performed using regression curves (quadratic regression), parameters for calculating roughness were obtained from data subjected to slope correction, and root-mean-square surface roughness (RMS) was obtained by calculating standard deviation. This surface roughness refers to the surface roughness of the positive electrode active material in at least a 400 nm square, including a particle surface portion.

On the surface of the particle of the positive electrode active material 100 of this embodiment, roughness (RMS: root-mean-square surface roughness), which is an index of roughness, is preferably less than 3 nm, further preferably less than 1 nm, still further preferably less than 0.5 nm.

Note that the image processing software used for the noise processing, the interface extraction, or the like is not particularly limited, and for example, “Imager can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as D50, have the same weight, and have ideal spherical shapes.

The median diameter D50 can be measured with a particle size analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area A_{R} to the ideal specific surface area Aᵢ obtained from the median diameter D50 (A_{R}/Aᵢ) is preferably less than or equal to 2.

This embodiment can be implemented in combination with the other embodiments.

### Embodiment 2

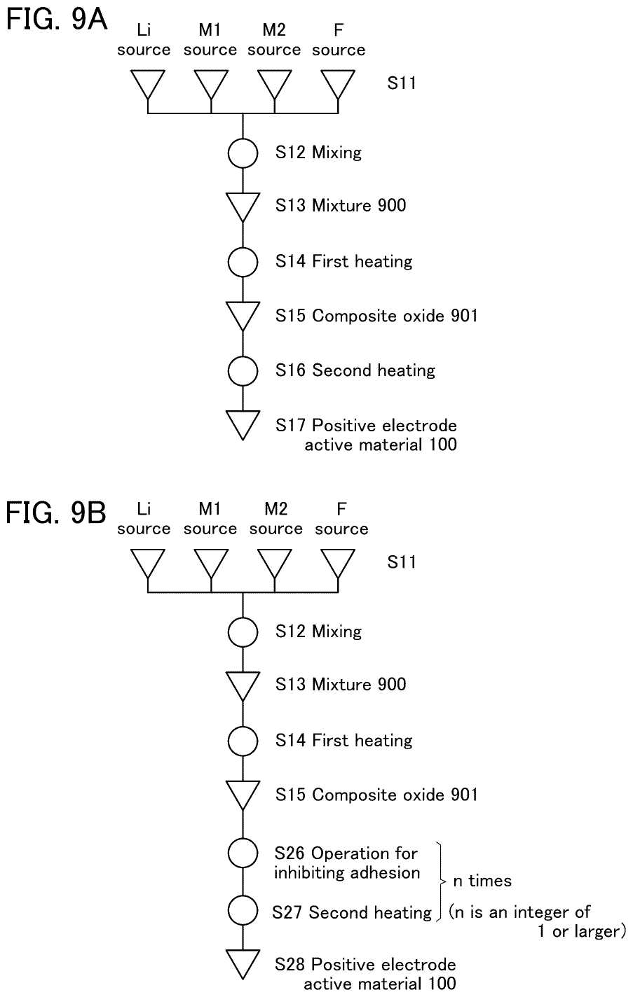

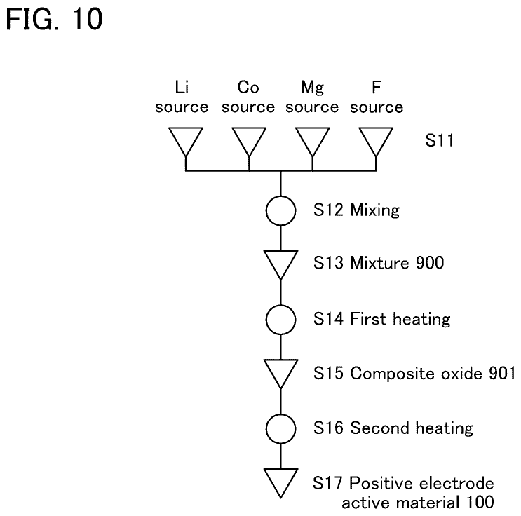

In this embodiment, an example of a method of forming a positive electrode active material of one embodiment of the present invention will be described with reference to FIG. 9A, FIG. 9B, and FIG. 10.

### <Step S11>

In Step S11 of FIG. 9A, a lithium source, a first metal M1 source, a second metal M2 source, and a fluorine source are prepared.

As the lithium source, for example, lithium carbonate, lithium fluoride, or the like can be used.

As mentioned in the above embodiment, a metal which together with lithium can form a composite oxide having the layered rock-salt structure belonging to the space group R-3m is preferably used as the first metal M. For example, at least one of manganese, cobalt, and nickel can be used.

As the first metal M1 source, oxide or hydroxide of the metal described as an example of the first metal M1, or the like can be used. As a cobalt source, for example, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

As the second metal M2, magnesium, aluminum, titanium, zirconium, niobium, lanthanum, yttrium, hafnium, or the like can be used as described in the above embodiment.

As the second metal M2 source, oxide, hydroxide, fluoride, alkoxide, or the like of the metal described as an example of the second metal M2 can be used.

As a magnesium source, for example, magnesium fluoride, magnesium oxide, magnesium hydroxide, magnesium carbonate, or the like can be used. As an aluminum source, for example, aluminum oxide, aluminum hydroxide, aluminum fluoride, aluminum alkoxide such as aluminum isopropoxide, or the like can be used. As a titanium source, titanium oxide, titanium hydroxide, titanium fluoride, titanium alkoxide such as titanium isopropoxide, or the like can be used. As a zirconium source, zirconium oxide, zirconium hydroxide, zirconium fluoride, zirconium alkoxide such as zirconium isopropoxide, or the like can be used. As a niobium source, niobium oxide, niobium hydroxide, niobium fluoride, niobium alkoxide, or the like can be used. As a lanthanum source, lanthanum oxide, lanthanum hydroxide, lanthanum fluoride, lanthanum alkoxide, or the like can be used.

### <Step S12>

Next, in Step S12, the lithium source, the first metal M1 source, the second metal M2 source, and the fluorine source are mixed. The mixing can be performed by a dry process or a wet process. For example, a ball mill, a bead mill, or the like can be used for the mixing. When the ball mill is used, a ball made of zirconium oxide is preferably used as a grinding medium, for example. Note that when alkoxide is used as the second metal M2 source, the alkoxide can be mixed via gelation. At this time, the grinding medium is not necessarily prepared.

### <Step S13>

The materials mixed in the above step are collected to give a mixture 900.

### <Step S14>

Next, in Step S14, the mixture 900 is heated. This step is sometimes referred to as first heating to distinguish this step from a heating step performed later.

Since some element sources, for example, LiF that can be the fluorine source and the lithium source is lighter than oxygen, the heating vaporizes LiF to decrease LiF in the mixture 900 in some cases. Thus, at the time of heating the mixture 900, the partial pressure of fluorine or a fluoride in the atmosphere is preferably controlled to be within an appropriate range. For example, a method of putting a lid on a heating crucible is employed.

The heating temperature is preferably greater than or equal to ⅔ of the melting point of a composite oxide 901 and less than or equal to the melting point. For example, in the case where cobalt occupies 80 atomic % or more of the first metal M1 included in the composite oxide 901, the heating temperature is preferably higher than or equal to 800° C. and lower than 1100° C., further preferably higher than or equal to 900° C. and lower than or equal to 1000° C., and still further preferably approximately 950° C. Alternatively, the heating temperature is preferably higher than or equal to 800° C. and lower than or equal to 1000° C. Alternatively, the heating temperature is preferably higher than or equal to 900° C. and lower than or equal to 1100° C. An excessively low temperature might result in insufficient decomposition and melting of the mixture 900. An excessively high temperature, on the other hand, might cause a defect due to excessive reduction of the metal taking part in an oxidation-reduction reaction and being used as the first metal M1, evaporation of lithium, or the like.

The heating time refers to a time taken for heating after the temperature reaches the target heating temperature. For example, the heating time can be longer than or equal to an hour and shorter than or equal to 100 hours, and is preferably longer than or equal to 2 hours and shorter than or equal to 20 hours. Alternatively, the heating time is preferably longer than or equal to an hour and shorter than or equal to 20 hours. Alternatively, the heating time is preferably longer than or equal to 2 hours and shorter than or equal to 100 hours. The first heating is preferably performed in an atmosphere with little water, such as dry air (e.g., the dew point is lower than or equal to −50° C., further preferably lower than or equal to −100° C.). For example, it is preferable that the heating be performed at 1000° C. for 10 hours, the temperature rise be 200° C./h, and the flow rate of a dry atmosphere be 10 L/min. After that, the heated materials can be cooled down to room temperature (25° C.). The temperature decreasing time from the specified temperature to room temperature is preferably longer than or equal to 10 hours and shorter than or equal to 50 hours, for example.

Note that the cooling down to room temperature in Step S14 is not essential. As long as the following Step S15 and Step S16 are performed without problems, the cooling may be performed to a temperature higher than room temperature. For example, cooling down to 100° C. or lower enables the following steps to be performed, which is preferable because the possibility of damaging a heating apparatus is low.

### <Step S15>

Through the above steps, the composite oxide 901 is obtained.

### <Step S16>

Next, in Step S16, the composite oxide 901 is heated. This step is referred to as second heating in some cases to distinguish this step from the heating step performed before.

Through this heating step, the second metal M2 and fluorine can be distributed at an appropriate concentrations in the surface portion 100a of the positive electrode active material 100.

Since the positive electrode active material 100 is formed through two-time heating, this formation method can be called a two-step method.

The reasons why this process allows the second metal M2, such as magnesium, and fluorine to be distributed at appropriate concentrations are divided into two aspects: the first is that these are not dissolved in the whole particles including the inner portion 100b of the positive electrode active material 100; and the second is that these remain in the surface portion even when being heated.

First, the reason why the second metal M2 and fluorine are less likely to be dissolved in the whole particles is that the second metal M2 and fluorine are energetically unstable in a layered rock-salt crystal structure such as lithium cobalt oxide. Although being unstable, a difference in stabilization energy between the second metal M2 and another element (the first metal M1 such as lithium and cobalt) is small. For this reason, when the second heating temperature is too high, entropy gain is larger and another compound such as MgCo₂O₄ is generated. Therefore, the second heating temperature is significantly important in this process.

Next, the reason why the second metal M2 and fluorine remain in the surface portion is firstly that the bond distance between the second metal M2 and oxygen is larger than the bond distance between the metal and oxygen in lithium cobalt oxide. Accordingly, even in the case where interdiffusion of elements occurs through multiple heating, and furthermore, even in the case where part of a particle is molten, the second metal M2 and fluorine remain in the surface and the surface portion 100a, which is more stable. In addition, in the surface portion, monovalent lithium and the divalent second metal M2, e.g., magnesium, are substituted. Therefore, part of divalent oxygen is preferably substituted with monovalent fluorine because electric charge is well balanced and crystal structure becomes more stable.

Also in Step S16, the partial pressure of fluorine or a fluoride in the atmosphere is preferably controlled to be within an appropriate range for the same reason in Step S14. For example, heating is preferably performed while a lid is put on a heating crucible.

The heating temperature in Step S16 needs to be a temperature at which interdiffusion of elements included in the composite oxide 901 occurs. For example, the heating temperature may be higher than or equal to 500° C., and is preferably higher than or equal to 742° C., further preferably higher than or equal to 830° C. The second heating temperature is preferably higher because higher temperature facilitates the reaction, shortens the heating time, and enables high productivity.

Note that the second heating temperature needs to be at least lower than or equal to a decomposition temperature of LiM1O₂ (1130° C. in the case of LiCoO₂). At around the decomposition temperature, a slight amount of LiMO₂ might be decomposed. Thus, the second heating temperature is preferably lower than or equal to 1130° C., further preferably lower than or equal to 1000° C., further preferably lower than or equal to 950° C., and further preferably lower than or equal to 900° C.

In view of the above, the second heating temperature is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the second heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the second heating temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 900° C.

Second heating is preferably performed for an appropriate time. The appropriate time of the second heating changes depending on conditions such as the temperature and the particle size and the composition of the composite oxide 901. In the case where the particle size is small, the heating is preferably performed at a lower temperature or for a shorter time than the case where the particle size is large, in some cases.

When the average particle diameter (D50) of the composite oxide 901 is approximately 12 μm, for example, the second heating temperature is preferably higher than or equal to 600° C. and lower than or equal to 950° C., for example. The second heating time is preferably longer than or equal to 3 hours, further preferably longer than or equal to 10 hours, still further preferably longer than or equal to 60 hours, for example.

On the other hand, when the average particle diameter (D50) of the composite oxide 901 is approximately 5 μm, the second heating temperature is preferably higher than or equal to 600° C. and lower than or equal to 950° C., for example. The second heating time is preferably longer than or equal to 1 hour and shorter than or equal to 10 hours, further preferably approximately 2 hours, for example.

The temperature decreasing time after the second heating is, for example, preferably longer than or equal to 10 hours and shorter than or equal to 50 hours.

### <Step S17>

The materials heated in the above are collected, whereby the positive electrode active material 100 is obtained.

Next, examples of a formation method different from that of FIG. 9A will be described with reference to FIG. 9B. Many portions are common to FIG. 9A; hence, different portions will be mainly described. The description of 9A can be referred to for the common portions.

As illustrated in Step S26 and Step S28 in FIG. 9B, the second heating may be performed once or multiple times. In addition, operation for inhibiting adhesion is preferably performed before the second heating. Examples of the operation for inhibiting adhesion include crushing with a pestle, mixing with a ball mill, mixing with a planetary centrifugal mixer, making the mixture pass through a sieve, and vibrating a container containing the composite oxide.

Such a formation method in which the second heating is conducted multiple times is effective particularly in the case where the amount to be heated at once is large (e.g., the case where the composite oxide 901 is 5 g or more). This is because when the amount to be heated at once is large, particles are likely to be bonded to one another, and distribution of the second metal M2 and fluorine in the surface portion 100a might not be in a favorable state.

FIG. 10 illustrates a more specific formation method of FIG. 9A. FIG. 10 illustrates an example of a formation method in which cobalt is used as the first metal and magnesium is used as the second metal.

This embodiment can be used in combination with the other embodiments.

### Embodiment 3

In this embodiment, a lithium-ion secondary battery including a positive electrode active material of one embodiment of the present invention will be described. The secondary battery at least includes an exterior body, a current collector, an active material (a positive electrode active material or a negative electrode active material), a conductive additive, and a binder. An electrolyte solution in which a lithium salt or the like is dissolved is also included. In the secondary battery using an electrolyte solution, a positive electrode, a negative electrode, and a separator between the positive electrode and the negative electrode are provided.

### [Positive Electrode]

The positive electrode includes a positive electrode active material layer and a positive electrode current collector. The positive electrode active material layer preferably includes the positive electrode active material described in Embodiment 1, and may further includes a binder, a conductive additive, or the like.

After the formation of the positive electrode, the positive electrode active material layer is sufficiently soaked in an electrolyte solution in the process of assembling and fabricating the secondary battery. Thus, the positive electrode active material layer in the secondary battery includes the electrolyte solution. In the case where the sufficient electrolyte solution soaks into the positive electrode active material layer, elements included in the electrolyte solution can be detected from a gap between the positive electrode active materials, the surface of the positive electrode active material, the surface of the current collector, and the like. For example, in the case where the electrolyte solution includes LiPF₆, phosphorus can be detected from these places.

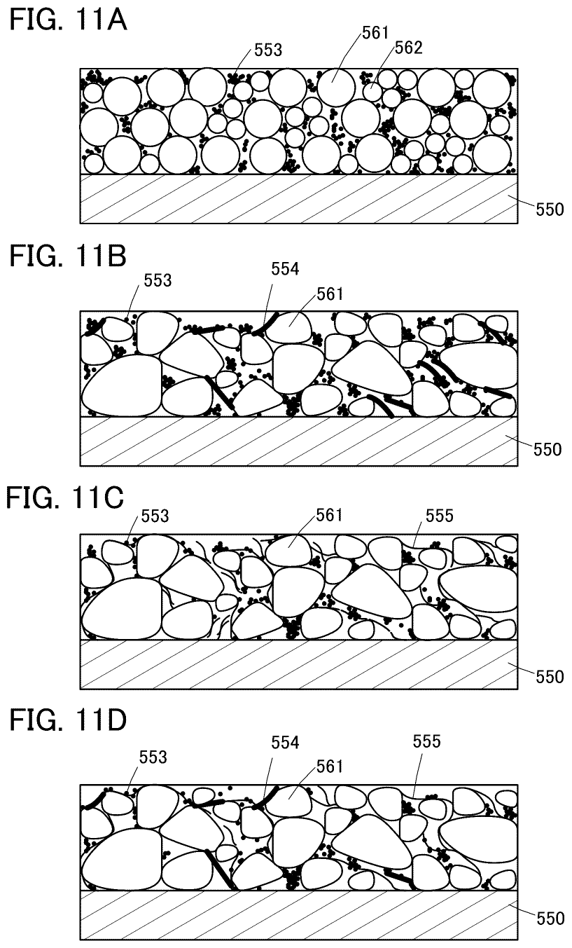

FIG. 11A illustrates an example of a cross-sectional view of the positive electrode.

A current collector 550 is metal foil, and the positive electrode is formed by applying slurry onto the metal foil and drying the slurry. Pressing may be performed after drying. The positive electrode is a component obtained by forming an active material layer over the current collector 550.

Slurry refers to a material solution that is used to form an active material layer over the current collector 550 and includes at least an active material, a binder, and a solvent, preferably also a conductive additive mixed therewith. Slurry may also be referred to as slurry for an electrode or active material slurry; in some cases, in the case of slurry for forming a positive electrode active material layer, slurry for a positive electrode is used, and slurry for forming a negative electrode active material layer is referred to as slurry for a negative electrode.

A conductive additive is also referred to as a conductivity-imparting agent or a conductive material, and a carbon material is used. A conductive additive is attached between a plurality of active materials, whereby the plurality of active materials are electrically connected to each other, and the conductivity increases. Note that the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

Typical examples of the carbon material used as the conductive additive include carbon black (e.g., furnace black, acetylene black, and graphite).

In FIG. 11A, acetylene black 553 is illustrated as the conductive additive. FIG. 11A illustrates an example in which a second active material 562 whose particle diameter is smaller than that of the positive electrode active material 100 described in Embodiment 1 is mixed. Particles with different sizes are mixed, whereby a high-density positive electrode active material layer can be provided and thus the charge and discharge capacity of the secondary battery can be increased. Note that the positive electrode active material 100 described in Embodiment 1 corresponds to an active material 561 in FIG. 11A.

In the positive electrode of the secondary battery, a binder (a resin) is mixed in order to fix the current collector 550 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is reduced to a minimum. In FIG. 11A, the region that is not filled with the active material 561, the second active material 562, or the acetylene black 553 represents a space or a binder.

Although FIG. 11A shows an example in which the active material 561 has a spherical shape, there is no particular limitation and other various shapes can be employed. The cross-sectional shape of the active material 561 may be an ellipse, a rectangle, a trapezoid, a pyramid, a quadrilateral with rounded corners, or an asymmetrical shape.

FIG. 11B shows an example in which the active materials 561 have various shapes. FIG. 11B shows the example different from that in FIG. 11A.

In the positive electrode in FIG. 11B, graphene 554 is used as a carbon material used as the conductive additive.

Graphene, which has electrically, mechanically, or chemically remarkable characteristics, is a carbon material that is expected to be applied to a variety of fields, such as field-effect transistors and solar batteries.

The graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably bent. The graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. The reduced graphene oxide functions by itself but may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

A graphene compound has excellent electrical characteristics of high conductivity and excellent physical properties of high flexibility and high mechanical strength in some cases. A graphene compound has a sheet-like shape. A graphene compound has a curved surface in some cases, thereby enabling low-resistant surface contact. Furthermore, a graphene compound has extremely high conductivity even with a small thickness in some cases and thus allows a conductive path to be formed in an active material layer efficiently even with a small amount. Hence, a graphene compound is preferably used as the conductive material, in which case the area where the active material and the conductive material are in contact with each other can be increased. Note that a graphene compound preferably clings to at least a portion of an active material particle. A graphene compound preferably overlays at least a portion of an active material particle. The shape of a graphene compound preferably conforms to at least a portion of the shape of active material particles. The shape of active material particles means, for example, an uneven surface of a single active material particle or an uneven surface formed by a plurality of active material particles. A graphene compound preferably surrounds at least a portion of an active material particle. A graphene compound may have a hole.

Here, a plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and weight. That is to say, the charge and discharge capacity of the secondary battery can be increased.

A material used in formation of the graphene compound may be mixed with the graphene compound to be used for the active material layer 200. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

In FIG. 11B, a positive electrode active material layer including the active material 561, the graphene 554, and the acetylene black 553 is formed over the current collector 550.

In the step of mixing the graphene 554 and the acetylene black 553 to obtain an electrode slurry, the weight of mixed carbon black is preferably 1.5 times to 20 times, further preferably 2 times to 9.5 times the weight of graphene.

When the graphene 554 and the acetylene black 553 are mixed in the above range, the acetylene black 553 can be dispersed uniformly and less likely to be aggregated at the time of preparing the slurry. Furthermore, when the graphene 554 and the acetylene black 553 are mixed in the above range, the electrode density can be higher than that of an electrode using only the acetylene black 553 as a conductive additive. As the electrode density is higher, the capacity per unit weight can be higher. Specifically, the density of the positive electrode active material layer measured by gravimetry can be higher than 3.5 g/cc. In addition, it is preferable that the positive electrode active material 100 described in Embodiment 1 be used for the positive electrode and the graphene 554 and the acetylene black 553 be mixed in the above range, in which case a synergy effect for higher capacity of the secondary battery can be expected.

The electrode density is lower than that of a positive electrode containing only graphene as a conductive additive, but when a first carbon material (graphene) and a second carbon material (acetylene black) are mixed in the above range, fast charging can be achieved. In addition, it is preferable that the positive electrode active material 100 described in Embodiment 1 be used for the positive electrode and the graphene 554 and the acetylene black 553 be mixed in the above ratio range, in which case synergy for higher stability and compatibility with faster charging of the secondary battery can be expected.

The above features are advantageous for secondary batteries for vehicles.

When a vehicle becomes heavier with an increasing number of secondary batteries, more energy is needed to move the vehicle, which shortens the driving range. With the use of a high-density secondary battery, the driving range of the vehicle can be maintained with almost no change in the total weight of a vehicle including a secondary battery having the same weight.

Since electric power is needed to charge the secondary battery with higher capacity in the vehicle, it is desirable to end charging fast. What is called a regenerative charging, in which electric power is temporarily generated when the vehicle is braked and the electric power is used for charging, is performed under high rate charging conditions; thus, a secondary battery for a vehicle is desired to have favorable rate characteristics.

Using the positive electrode active material 100 described in Embodiment 1 for the positive electrode and mixing acetylene black and graphene within an optimal range enable both higher electrode density and formation of an appropriate space needed for ion conduction, whereby a secondary battery for a vehicle which has high energy density and favorable output characteristics can be obtained.

This structure is also effective in a portable information terminal, and using the positive electrode active material 100 described in Embodiment 1 for the positive electrode and setting the mixing ratio of acetylene black to graphene in the optimal range enable a small secondary battery with high capacity. Setting the mixing ratio of acetylene black to graphene in the optimal range also enables fast charging of a portable information terminal.

In FIG. 11B, the region that is not filled with the active material 561, the graphene 554, or the acetylene black 553 represents a space or a binder. A space is required for the electrolyte solution to penetrate the positive electrode; too many spaces lower the electrode density, too few spaces do not allow the electrolyte solution to penetrate the positive electrode, and a space that remains after the secondary battery is completed lowers the energy density.

Using the positive electrode active material 100 described in Embodiment 1 for the positive electrode and setting the mixing ratio of acetylene black and graphene in the optimal range enable both higher electrode density and formation of an appropriate space needed for ion conduction, whereby a secondary battery which has high energy density and favorable output characteristics can be obtained.

FIG. 11C shows an example of a positive electrode in which a carbon nanotube 555 is used instead of graphene. FIG. 11C shows the example different from that in FIG. 11B. With the use of the carbon nanotube 555, aggregation of carbon black such as the acetylene black 553 can be prevented and the dispersibility can be increased.

In FIG. 11C, the region that is not filled with the active material 561, the carbon nanotube 555, or the acetylene black 553 represents a space or a binder.

FIG. 11D shows another example of a positive electrode. FIG. 11C shows an example in which the carbon nanotube 555 is used in addition to the graphene 554. With the use of both the graphene 554 and the carbon nanotube 555, aggregation of carbon black such as the acetylene black 553 can be prevented and the dispersibility can be further increased.

In FIG. 11D, the region that is not filled with the active material 561, the carbon nanotube 555, the graphene 554, or the acetylene black 553 represents a space or a binder.

A secondary battery can be manufactured by using any one of the positive electrodes in FIG. 11A to FIG. 11D; setting, in a container (e.g., an exterior body or a metal can) or the like, a stack in which a separator is provided over the positive electrode and a negative electrode is provided over the separator; and filling the container with an electrolyte solution.

Although the above structure is an example of a secondary battery using an electrolyte solution, one embodiment of the present invention is not particularly limited thereto.

For example, a semi-solid-state battery or an all-solid-state battery can be fabricated using the positive electrode active material 100 described in Embodiment 1.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery. A polymer electrolyte secondary battery may be referred to as a semi-solid-state battery.

A semi-solid-state battery manufactured using the positive electrode active material 100 described in Embodiment 1 is a secondary battery having high charge and discharge capacity. The semi-solid-state battery can have high charge and discharge voltages. Alternatively, a highly safe or reliable semi-solid-state battery can be provided.

The positive electrode active material described in Embodiment 1 and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to add lithium nickel oxide (LiNiO₂ or LiNi₁₋ₓMₓO₂ (0<x<1) (M=Co, Al, or the like)) to a lithium-containing material with a spinel crystal structure which contains manganese, such as LiMn₂O₄, because the characteristics of the secondary battery including such a material can be improved.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c>0; and 0.26 (b+c)/d<0.5. Note that the proportions of metals, silicon, phosphorus, and other elements in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICP-MS combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### <Positive Electrode Current Collector>

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer contains a negative electrode active material, and may further contain a conductive additive and a binder.

### <Negative Electrode Active Material>

As a negative electrode active material, for example, an alloy-based material or a carbon-based material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, or preferably greater than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those of the conductive additive and the binder that can be included in the positive electrode active material layer can be used.

### <Negative Electrode Current Collector>

For the negative electrode current collector, copper or the like can be used in addition to a material similar to that of the positive electrode current collector. Note that a material that is not alloyed with carrier ions of lithium or the like is preferably used for the negative electrode current collector.

### [Separator]

A separator is positioned between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at a deep charge depth can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte Solution]

The electrolyte solution contains a solvent and an electrolyte. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) that are unlikely to burn and volatize as the solvent of the electrolyte solution can prevent a power storage device from exploding or catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more of these lithium salts can be used in an appropriate combination at an appropriate ratio.

The electrolyte solution used for a power storage device is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of the additive in the whole solvent is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like may alternatively be used. When the solid electrolyte is used, a separator and a spacer are not necessary. Furthermore, the battery can be entirely solidified; therefore, there is no possibility of liquid leakage and thus the safety of the battery is dramatically improved.

Accordingly, the positive electrode active material 100 described in Embodiment 1 can also be applied to all-solid-state batteries. By using the positive electrode slurry or the electrode in an all-solid-state battery, an all-solid-state battery with a high degree of safety and favorable characteristics can be obtained.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be used in combination with the other embodiments.

### Embodiment 4

This embodiment describes examples of shapes of several types of secondary batteries including a positive electrode or a negative electrode formed by the manufacturing method described in the foregoing embodiment.

### [Coin-Type Secondary Battery]

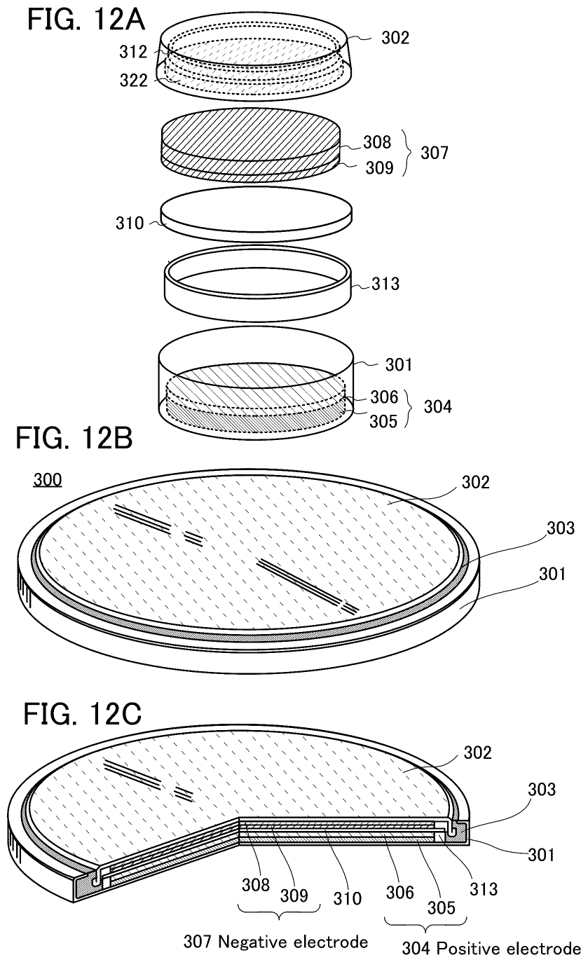

An example of a coin-type secondary battery is described. FIG. 12A is an exploded perspective view of a coin-type (single-layer flat type) secondary battery, FIG. 12B is an external view thereof, and FIG. 12C is a cross-sectional view thereof. Coin-type secondary batteries are mainly used in small electronic devices.

For easy understanding, FIG. 12A is a schematic view showing overlap (a vertical relation and a positional relation) between components. Thus, FIG. 12A and FIG. 12B do not completely correspond with each other.

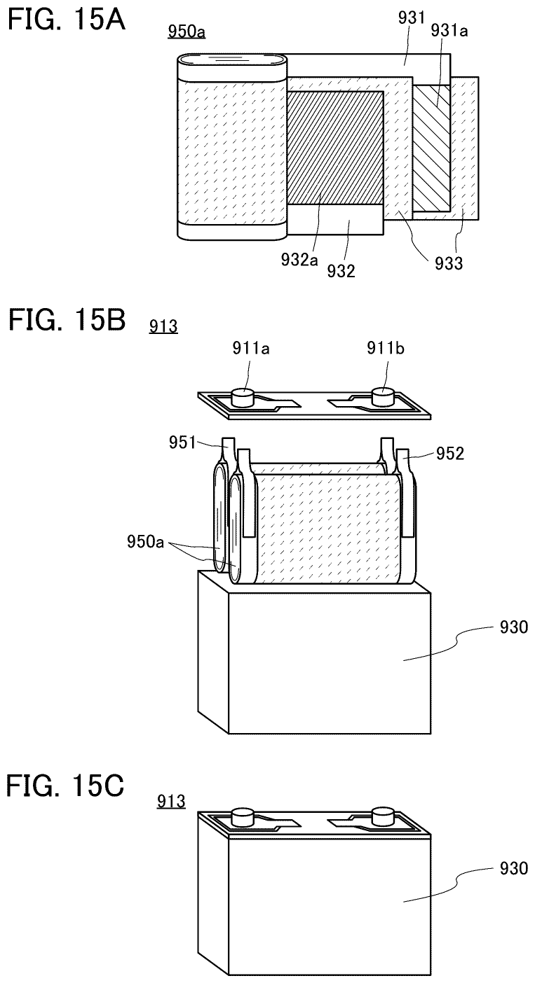

In FIG. 12A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 15A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stack structure in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 12B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte solution; as illustrated in FIG. 12C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

The secondary battery can be the coin-type secondary battery 300 having high capacity, high charge and discharge capacity, and excellent cycle performance. Note that in the case of a secondary battery, the separator 310 is not necessarily provided between the negative electrode 307 and the positive electrode 304.

### [Cylindrical Secondary Battery]

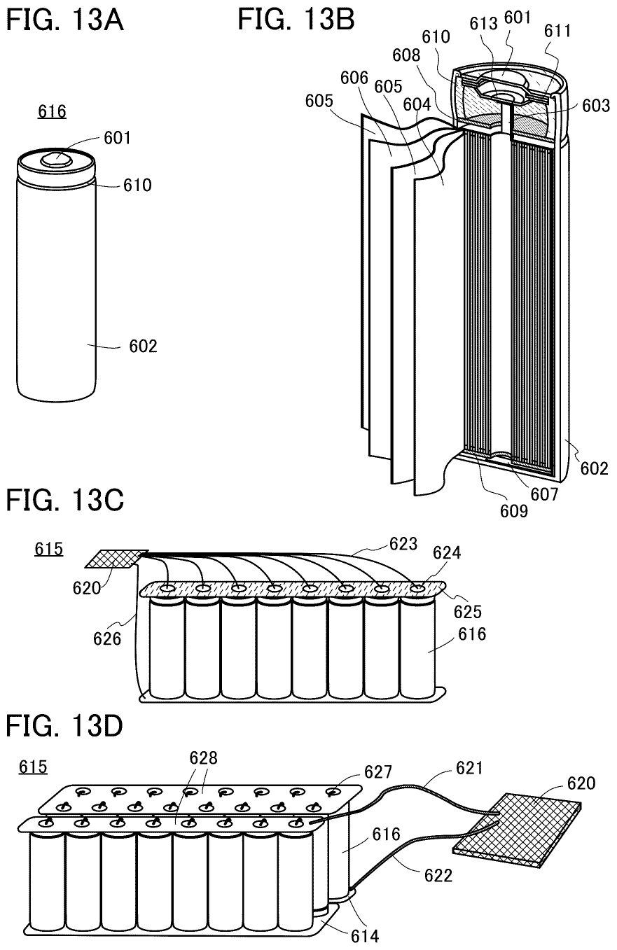

An example of a cylindrical secondary battery is described with reference to FIG. 13A. As illustrated in FIG. 13A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 13B schematically illustrates a cross section of a cylindrical secondary battery. The cylindrical secondary battery illustrated in FIG. 13B includes the positive electrode cap (battery cap) 601 on the top surface and the battery can (outer can) 602 on the side surface and the bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). A nonaqueous electrolyte solution similar to that for the coin-type secondary battery can be used.

Since a positive electrode and a negative electrode that are used for a cylindrical storage battery are wound, active materials are preferably formed on both surfaces of a current collector.

The positive electrode active material 100 obtained in Embodiment 1 is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 13C shows an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like or a protection circuit for preventing overcharging or overdischarging can be used.

FIG. 13D shows an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 13D, the power storage system 615 is electrically connected to the control circuit 620 through a wiring 621 and a wiring 622. The wiring 621 is electrically connected to the positive electrodes of the plurality of secondary batteries through the conductive plate 628. The wiring 622 is electrically connected to the negative electrodes of the plurality of secondary batteries 616 through the conductive plate 614.

### [Other Structure Examples of Secondary Battery]

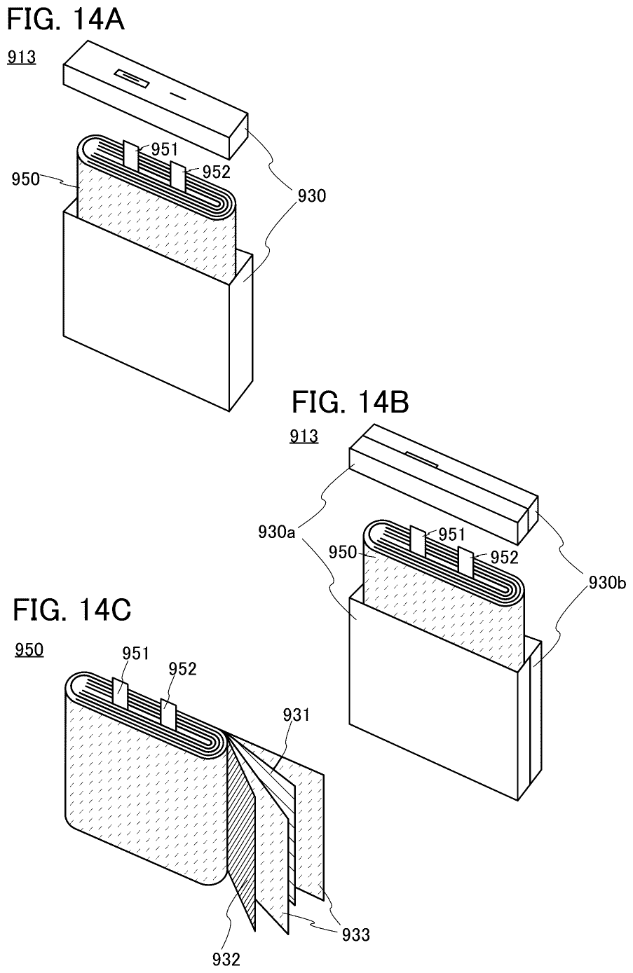

Structure examples of secondary batteries are described with reference to FIG. 14 and

FIG. 15.

A secondary battery 913 illustrated in FIG. 14A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 14A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 14B, the housing 930 in FIG. 14A may be formed using a plurality of materials. For example, in the secondary battery 913 illustrated in FIG. 14B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 14C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 15, the secondary battery 913 may include a wound body 950a. The wound body 950a illustrated in FIG. 15A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in Embodiment 1 is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 15A and FIG. 15B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 15C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 15B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 14A to FIG. 14C can be referred to for the other components of the secondary battery 913 illustrated in FIG. 15A and FIG. 15B.

### <Laminated Secondary Battery>

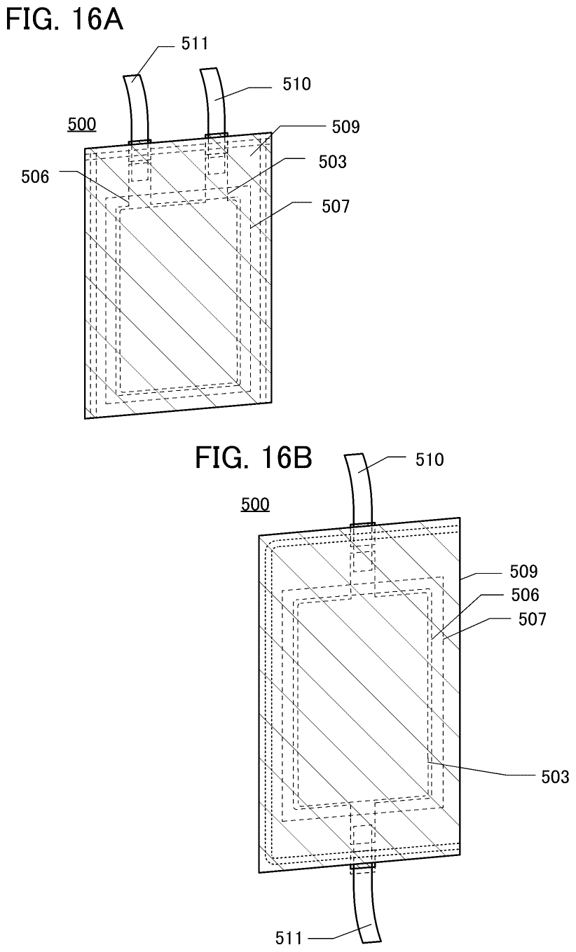

Next, examples of the appearance of a laminated secondary battery are shown in FIG. 16A and FIG. 16B. FIG. 16A and FIG. 16B each include a positive electrode 503, a negative electrode 506, a separator 507, an exterior body 509, a positive electrode lead electrode 510, and a negative electrode lead electrode 511.

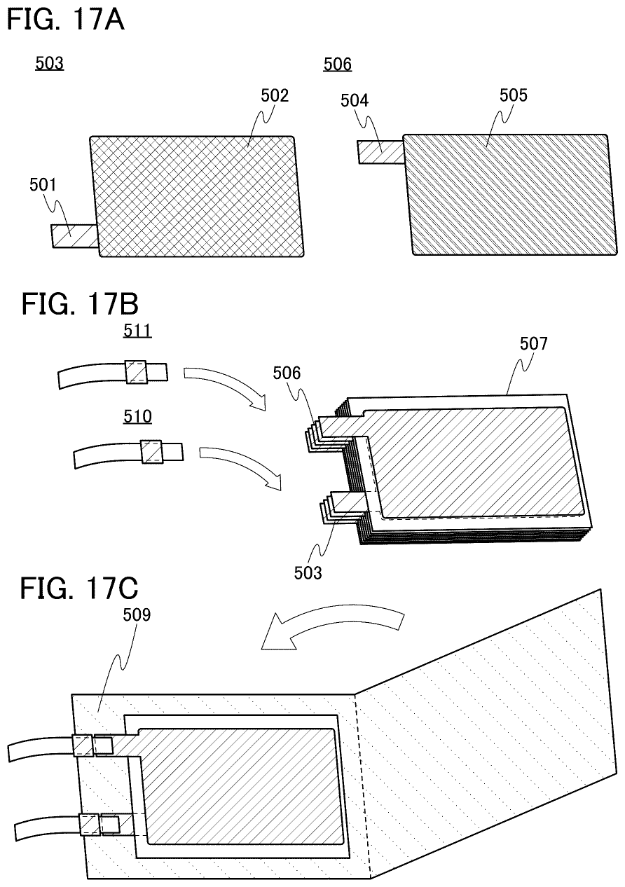

FIG. 17A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples shown in FIG. 17A.

### <Method for Manufacturing Laminated Secondary Battery>

Here, an example of a method for manufacturing the laminated secondary battery whose external view is shown in FIG. 16A is described with reference to FIG. 17B and FIG. 17C.

First, the negative electrode 506, the separator 507, and the positive electrode 503 are stacked. FIG. 17B illustrates the negative electrodes 506, the separators 507, and the positive electrodes 503 that are stacked. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a portion shown by a dashed line, as illustrated in FIG. 17C. Then, the outer edges of the exterior body 509 are bonded to each other. The bonding can be performed by thermocompression, for example. At this time, an unbonded region (hereinafter referred to as an inlet) is provided for part (or one side) of the exterior body 509 so that an electrolyte solution can be introduced later.

Next, the electrolyte solution (not illustrated) is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be manufactured.

The positive electrode active material 100 obtained in Embodiment 1 is used for the positive electrode 503, whereby the secondary battery 500 can have high capacity, high charge and discharge capacity, and excellent cycle performance.

### [Examples of Battery Pack]

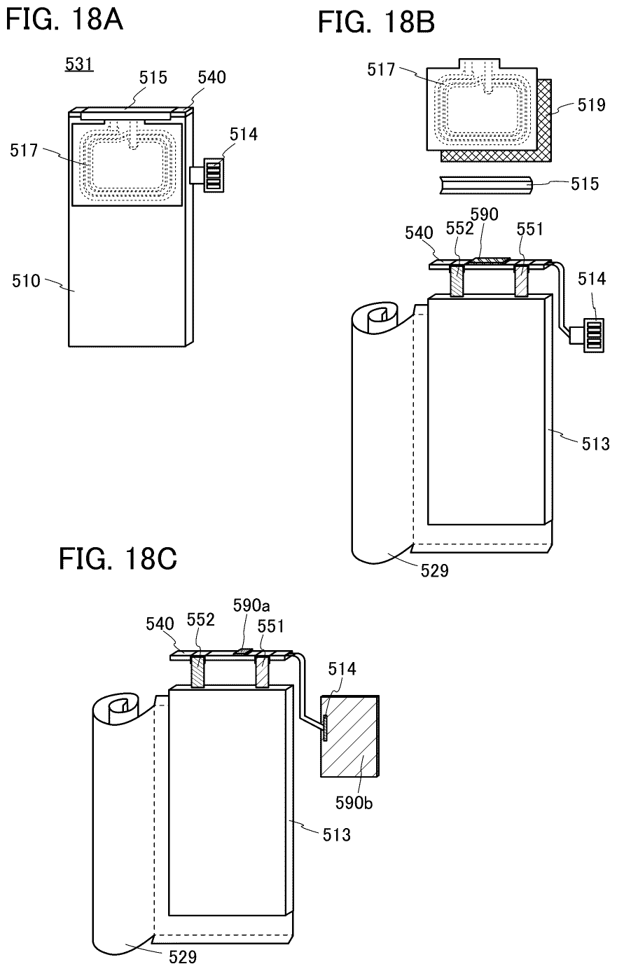

Examples of a secondary battery pack of one embodiment of the present invention that is capable of wireless charging using an antenna will be described with reference to FIG. 18.

FIG. 18A is a diagram illustrating the appearance of a secondary battery pack 531 that has a rectangular solid shape with a small thickness (also referred to as a flat plate shape with a certain thickness). FIG. 18B illustrates a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 18B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 18C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

This embodiment can be freely combined with the other embodiments.

### Embodiment 5

In this embodiment, an example where an all-solid-state battery is fabricated using the positive electrode active material 100 described in Embodiment 1 will be described.

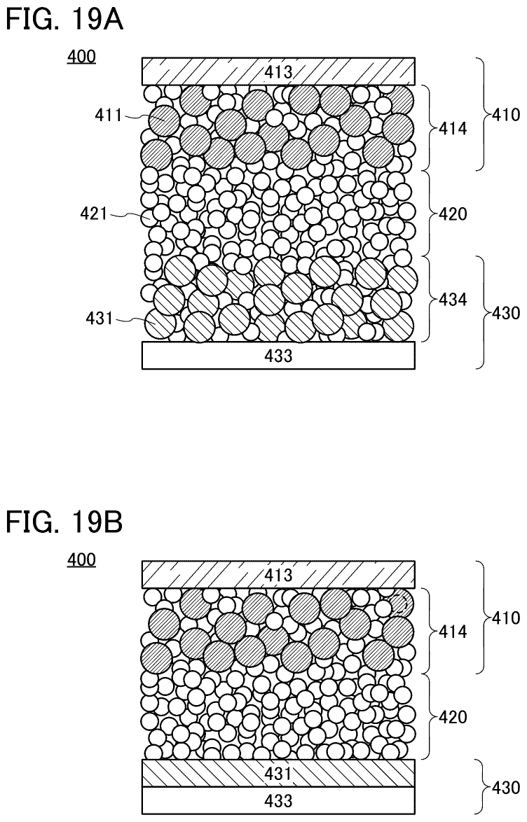

As illustrated in FIG. 19A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 100 described in Embodiment 1 is used as the positive electrode active material 411, and a boundary between a core region and a shell region is indicated by a dotted line. The positive electrode active material layer 414 may include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. When metal lithium is used for the negative electrode 430, it is possible that the negative electrode 430 does not include the solid electrolyte 421 as illustrated in FIG. 19B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-silicon-based material (e.g., Li₁₀GeP₂S₁₂ or Li_{3.25}Ge_{0.25}P_{0.75}S₄), sulfide glass (e.g., 70Li₂S·₃₀P₂S₅, 30Li₂S·₂₆B₂S₃·44LiI, 63Li₂S·38SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

The oxide-based solid electrolyte includes a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄-Li₄SiO₄ or 50Li₄SiO₄·50Li₃BO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

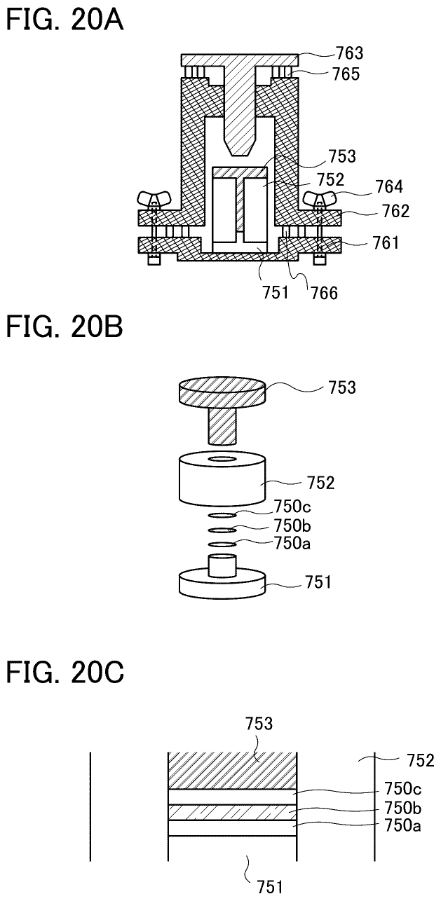

FIG. 20 illustrates an example of a cell for evaluating materials of an all-solid-state battery, for example.

FIG. 20A is a cross-sectional view of the evaluation cell, and the evaluation cell includes a lower component 761, an upper component 762, and a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 20B is an enlarged perspective view of the evaluation material and its vicinity.

A stack of a positive electrode 750a, a solid electrolyte layer 750b, and a negative electrode 750c is shown here as an example of the evaluation material, and its cross-sectional view is illustrated in FIG. 20C. Note that the same portions in FIG. 20A to FIG. 20C are denoted by the same reference numerals.

The electrode plate 751 and the lower component 761 that are electrically connected to the positive electrode 750a can be said to correspond to a positive electrode terminal. The electrode plate 753 and the upper component 762 that are electrically connected to the negative electrode 750c can be said to correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package and/or a resin package can be used. The exterior body is sealed preferably in a closed atmosphere where the outside air is blocked, for example, in a glove box.

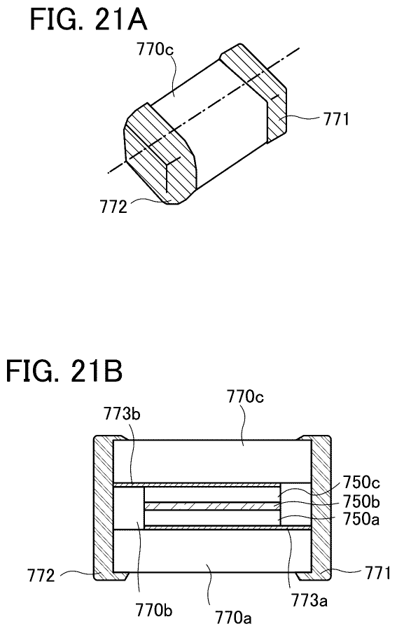

FIG. 21A illustrates a perspective view of a secondary battery of one embodiment of the present invention that has an exterior body and a shape different from those in FIG. 20. The secondary battery in FIG. 21A includes external electrodes 771 and 772 and is sealed with an exterior body including a plurality of package components.

FIG. 21B illustrates an example of a cross section along the dashed-dotted line in FIG. 21A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and/or ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 described in Embodiment 1 can achieve an all-solid-state secondary battery having a high energy density and favorable output characteristics.

This embodiment can be used in appropriate combination with the other embodiments.

### Embodiment 6

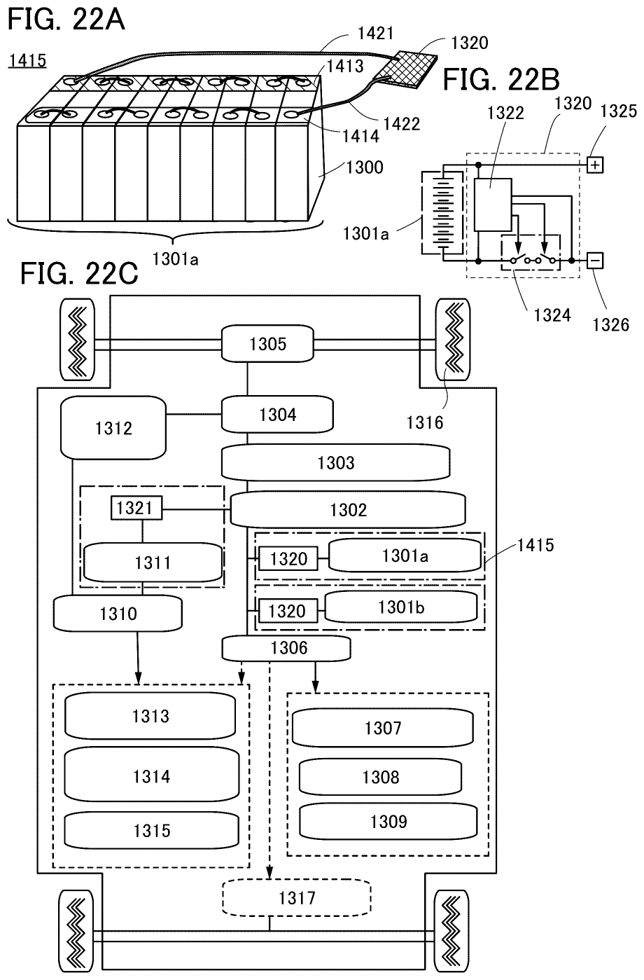

An example that is different from the cylindrical secondary battery in FIG. 13D is described in this embodiment. An application example of the secondary battery in an electric vehicle (EV) is described with reference to FIG. 22C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 14A or FIG. 15C or the stacked-layer structure illustrated in FIG. 16A or FIG. 16B. Alternatively, the first battery 1301a may be the all-solid-state battery in Embodiment 5. The use of the all-solid-state battery in Embodiment 5 as the first battery 1301a can achieve high capacity, improvement in safety, and reduction in size and weight.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

In order to cut off electric power from the plurality of secondary batteries, the secondary batteries in the vehicle include a service plug or a circuit breaker which can cut off a high voltage without the use of equipment; these are provided in the first battery 1301a.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as an audio 1313, a power window 1314, and lamps 1315) through a DCDC circuit 1310.

The first battery 1301a will be described with reference to FIG. 22A.

FIG. 22A illustrates an example in which nine rectangular secondary batteries 1300 form one battery pack 1415. The nine rectangular secondary batteries 1300 are connected in series; one electrodes are fixed by a fixing portion 1413 made of an insulator, and the other electrodes are fixed by a fixing portion 1414 made of an insulator. Although this embodiment shows an example in which the secondary batteries are fixed by the fixing portions 1413 and 1414, a structure in which the secondary batteries are stored in a battery container box (also referred to as a housing) may be employed. Since a vibration or a jolt is assumed to be given to the vehicle from the outside (e.g., a road surface), the plurality of secondary batteries are preferably fixed by the fixing portions 1413 and 1414. a battery container box, or the like. Furthermore, the one electrodes are electrically connected to a control circuit portion 1320 through a wiring 1421. The other electrodes are electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the orientation of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide is a region having [In] higher than [In] in the composition of the CAC-OS film. Moreover, the second region is a region having [Ga] higher than [Ga] in the composition of the CAC-OS film. Alternatively, for example, the first region is a region having [In] higher than [In] in the second region and [Ga] lower than [Ga] in the second region. Moreover, the second region is a region having [Ga] higher than [Ga] in the first region and [In] lower than [In] in the first region.

Specifically, the first region is a region containing an indium oxide, an indium zinc oxide, or the like as its main component. The second region is a region containing a gallium oxide, a gallium zinc oxide, or the like as its main component. That is, the first region can be rephrased as a region containing In as its main component. The second region can be rephrased as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Iₒₙ), high field-effect mobility (μ), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. The operating ambient temperatures of a transistor using an oxide semiconductor in its semiconductor layer are wider than those of a single crystal transistor and are higher than or equal to −40° C. and lower than or equal to 150° C., which causes less change of characteristics compared with a single crystal Si transistor when the secondary battery is heated. The off-state current of the transistor using an oxide semiconductor is lower than or equal to the lower measurement limit even at 150° C. independently of the temperature; meanwhile, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery whose positive electrode active material 100 described in Embodiment 1, the synergy on safety can be obtained. The secondary battery whose positive electrode active material 100 described in Embodiment 1 and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharge, prevention of overcurrent, control of overheating during charge, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers to not a state where the positive electrode and the negative electrode of a secondary battery are short-circuited so that charge and discharge are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: a plurality of charge and discharge cause an uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharge, an output transistor of a charge circuit and an interruption switch can be turned off substantially at the same time.

FIG. 22A illustrates an example of a block diagram of the battery pack 1415 illustrated in FIG. 22B.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors and/or p-channel transistors. The switch portion 1324 is not limited to including a switch using a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium-ion secondary batteries in that they have a larger amount of self-discharge and are more likely to deteriorate due to a phenomenon called sulfation. There is an advantage that the second battery 1311 can be maintenance-free when a lithium-ion secondary battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 5 may be used. The use of the all-solid-state battery in Embodiment 5 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through the control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charge.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, when the electric vehicle is connected to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU and/or a GPU.

External chargers installed at charge stations and the like have a 100 V outlet, a 200 V outlet, and a three-phase 200 V outlet with 50 kW, for example. Furthermore, charge can be performed by electric power supplied from an external charge equipment with a contactless power feeding method or the like.

For fast charge, secondary batteries that can withstand charge with a high voltage have been desired to perform charge in a short time.

The above secondary battery in this embodiment uses the positive electrode active material 100 obtained in Embodiment 1 and thus includes a high-density positive electrode. Furthermore, graphene is used as a conductive additive and an electrode layer is formed thick so that a reduction in capacity can be inhibited while the loading amount is increased. Moreover, the maintenance of high capacity can be obtained as synergy; thus, it is possible to achieve a secondary battery whose electrical characteristics are significantly improved. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above secondary battery in this embodiment, the use of the positive electrode active material 100 described in Embodiment 1 can increase the operating voltage of the secondary battery, and the increase in charge voltage can increase the available capacity. Moreover, using the positive electrode active material 100 described in Embodiment 1 in the positive electrode can provide an automotive secondary battery having excellent cycle performance.

Next, examples in which the secondary battery of one embodiment of the present invention is mounted on a vehicle, typically a transport vehicle, are described.

Mounting the secondary battery illustrated in either FIG. 13D, FIG. 15C, or FIG. 22A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

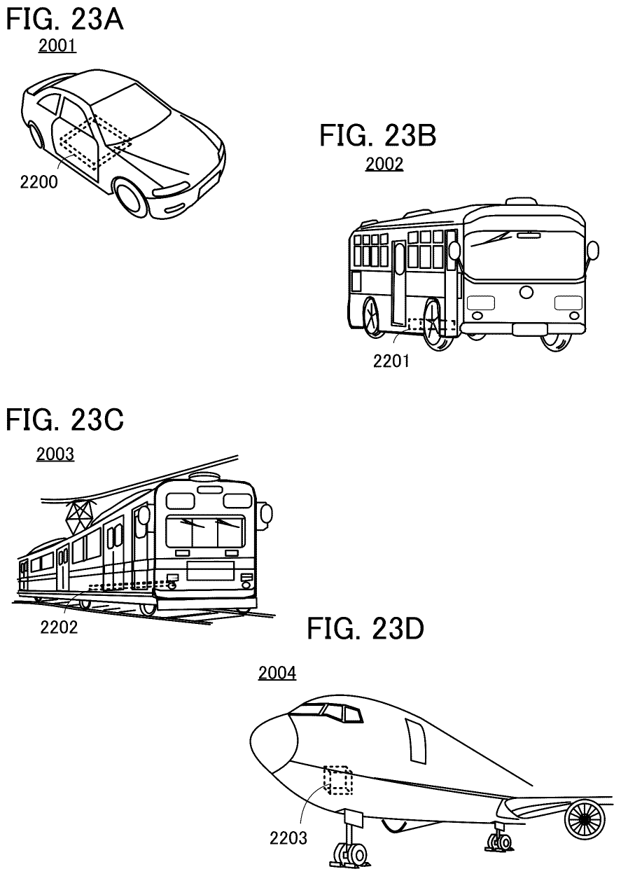

FIG. 23A to FIG. 23D show examples of transport vehicles using one embodiment of the present invention. An automobile 2001 illustrated in FIG. 23A is an electric vehicle that runs on an electric motor as a power source. Alternatively, the automobile 2001 is a hybrid vehicle that can appropriately select an electric motor or an engine as a driving power source. In the case where the secondary battery is mounted on the vehicle, an example of the secondary battery described in Embodiment 4 is provided at one position or several positions. The automobile 2001 illustrated in FIG. 23A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power from external charging equipment by a plug-in system, a contactless charging system, or the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, with the use of the plug-in system, the power storage device mounted on the automobile 2001 can be charged by being supplied with electric power from the outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method and/or a magnetic resonance method can be used.

FIG. 23B shows a large transporter 2002 having a motor controlled by electric power, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 23A except, for example, the number of secondary batteries configuring the secondary battery module; thus, the description is omitted.

FIG. 23C shows a large transport vehicle 2003 having a motor controlled by electricity as an example. The secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have few variations in the characteristics. By employing the positive electrode active material 100 for the positive electrode, a secondary battery having stable battery characteristics can be manufactured and mass production at low cost is possible in light of the yield. A battery pack 2202 has a function similar to that in FIG. 23A except that the number of secondary batteries forming the secondary battery module of the battery pack 2202 or the like is different; thus, the detailed description is omitted.

FIG. 23D shows an aircraft 2004 having a combustion engine as an example. The aircraft 2004 shown in FIG. 23D can be regarded as a kind of transport vehicles since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 23A except, for example, the number of secondary batteries configuring the secondary battery module; thus, the description is omitted.

This embodiment can be implemented in appropriate combination with any of the other embodiments.

### Embodiment 7

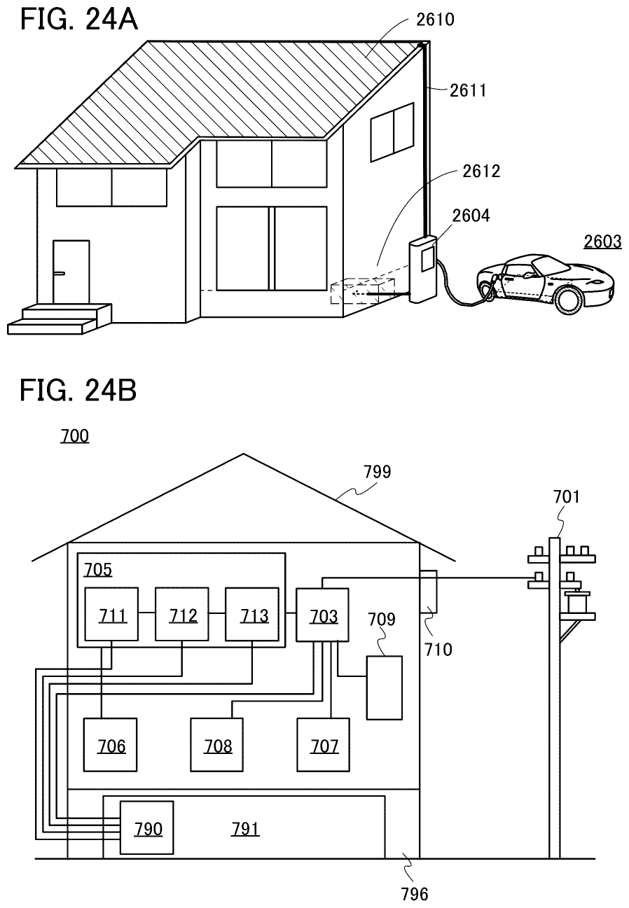

In this embodiment, examples in which the secondary battery of one embodiment of the present invention is mounted on a building are described with reference to FIG. 24A and FIG. 24B.

A house illustrated in FIG. 24A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to ground-based charging equipment 2604. The power storage device 2612 can be charged with electric power generated by the solar panel 2610. A secondary battery included in a vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 24B shows an example of a power storage device 700 of one embodiment of the present invention. As shown in FIG. 24B, a power storage device 791 of one embodiment of the present invention is provided in an underfloor space 796 of a building 799. The power storage device 791 may be provided with the control circuit described in Embodiment 6, and when a secondary battery including the positive electrode active material 100 described in Embodiment 1 is used for the power storage device 791, the synergy on safety can be obtained. The secondary battery including the control circuit described in Embodiment 1 and the positive electrode using the positive electrode active material 100 described in Embodiment 1 can contribute greatly to elimination of accidents due to the power storage device 791 including secondary batteries, such as fires.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not shown).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

This embodiment can be implemented in appropriate combination with any of the other embodiments.

### Embodiment 8

In this embodiment, examples in which a motorcycle or a bicycle is provided with the power storage device of one embodiment of the present invention will be described.

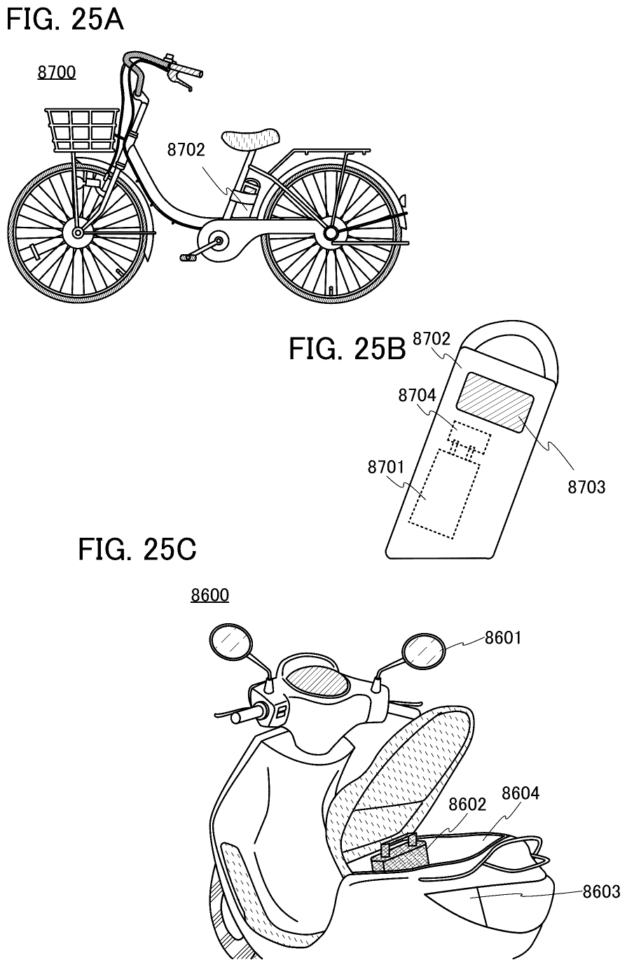

FIG. 25A illustrates an example of an electric bicycle using the power storage device of one embodiment of the present invention. The power storage device of one embodiment of the present invention can be used for an electric bicycle 8700 illustrated in FIG. 25A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 25B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may be provided with the small solid-state secondary battery illustrated in FIG. 21A and FIG. 21B. When the small solid-state secondary battery illustrated in FIG. 21A and FIG. 21B is provided in the control circuit 8704, electric power can be supplied to store data in a memory circuit included in the control circuit 8704 for a long time. When the control circuit 8704 is used in combination with the secondary battery including the positive electrode active material 100 obtained in Embodiment 1 in the positive electrode, the synergy on safety can be obtained. The secondary battery including the positive electrode active material 100 obtained in Embodiment 1 in the positive electrode and the control circuit 8704 can greatly contribute to elimination of accidents due to secondary batteries, such as fires.

FIG. 25C illustrates an example of a motorcycle using the power storage device of one embodiment of the present invention. A motor scooter 8600 illustrated in FIG. 25C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in Embodiment 1 can have high capacity and contribute to a reduction in size.

In the motor scooter 8600 illustrated in FIG. 25C, the power storage device 8602 can be stored in a storage unit under seat 8604. The power storage device 8602 can be stored in the storage unit under seat 8604 even with a small size.

### Embodiment 9

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

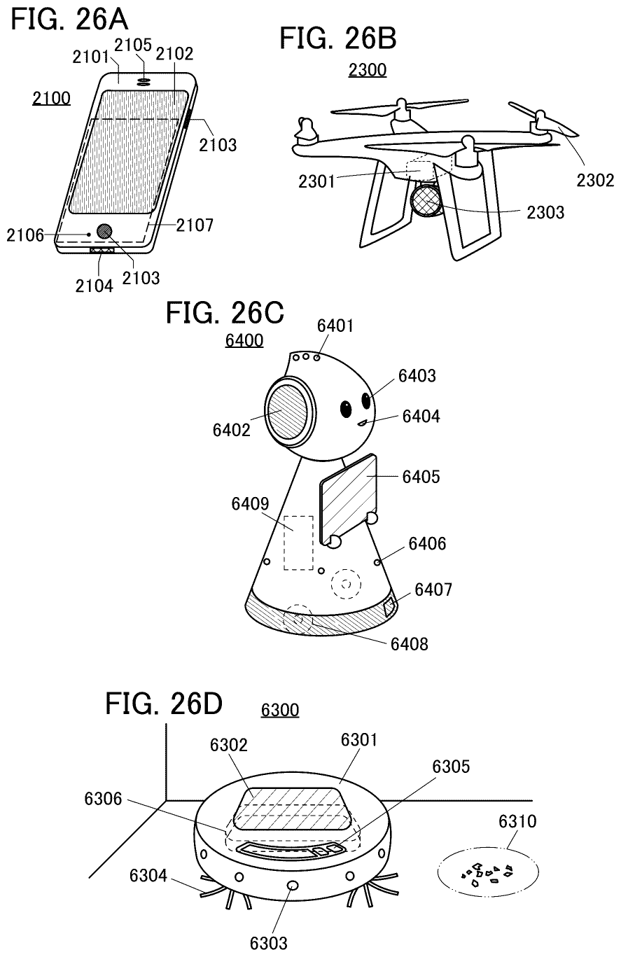

FIG. 26A shows an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material 100 described in Embodiment 1 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 26B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in Embodiment 1 has high energy density and a high degree of safety, and thus can be used safely for a long time over a long period of time and is preferable as the secondary battery included in the unmanned aircraft 2300.

FIG. 26C shows an example of a robot. A robot 6400 illustrated in FIG. 26C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in Embodiment 1 has high energy density and a high degree of safety, and thus can be used safely for a long time over a long period of time and is preferable as the secondary battery 6409 included in the robot 6400.

FIG. 26D shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in Embodiment 1 has high energy density and a high degree of safety, and thus can be used safely for a long time over a long period of time and is preferable as the secondary battery 6306 included in the cleaning robot 6300.

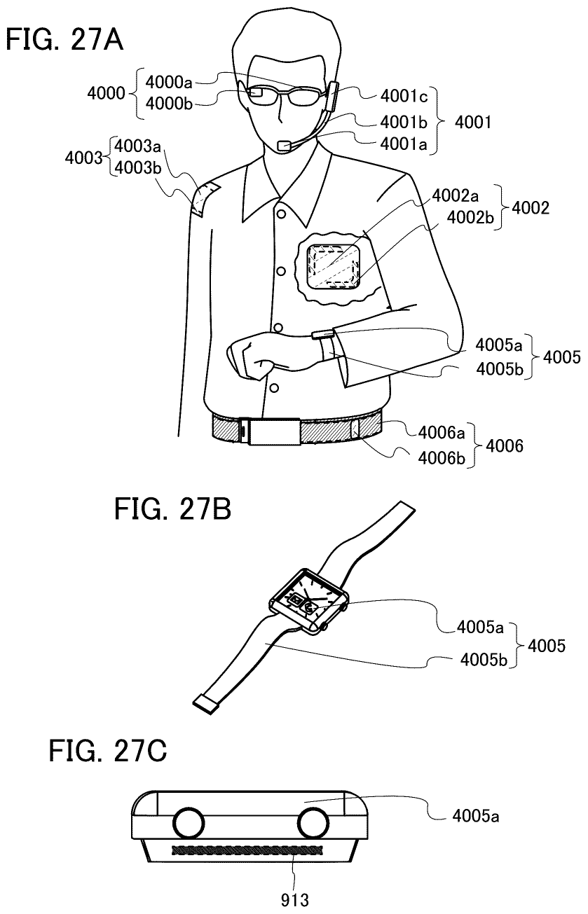

FIG. 27A shows examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 27A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and/or the earphone portion 4001c. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in Embodiment 1 has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in Embodiment 1 has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 27B is a perspective view of the watch-type device 4005 that is detached from an arm.

FIG. 27C is a side view. FIG. 27C illustrates a state where the secondary battery 913 is incorporated in the inner region. The secondary battery 913 is the secondary battery described in Embodiment 4. The secondary battery 913 is provided to overlap the display portion 4005a, can have high density and high capacity, and is small and lightweight.

Since the secondary battery in the watch-type device 4005 is required to be small and lightweight, the use of the positive electrode active material 100 obtained in Embodiment 1 in the positive electrode of the secondary battery 913 enables the secondary battery 913 to have high energy density and a small size.

This embodiment can be implemented in appropriate combination with the other embodiments.

### Example

In this example, the positive electrode active material of one embodiment of the present invention was formed, elementary analysis was performed with XPS, the cycle performance was evaluated, and the crystal structure after charging was analyzed.

### <Formation of Positive Electrode Active Material>

Samples formed in this example are described with reference to the formation method illustrated in FIG. 10.

In Step S11, lithium carbonate, cobalt carbonate, magnesium oxide, and lithium fluoride were used as a lithium source, a cobalt source, a magnesium source, and a fluorine source and lithium source, respectively. These materials were weighed to be Li_{1.02}Co_{0.99}Mg_{0.01}O_{1.98}F_{0.02} in composition. Next, these were mixed as shown in Step S12, whereby the mixture 900 was obtained (Step S13).

Next, as shown in Step S14, the mixture 900 was subjected to the first heating. The mixture 900 was put in a crucible made of aluminum oxide, the crucible was covered with a lid, and heating was performed in a muffle furnace. The heating temperature was set to 1000° C., the heating time was set to 10 hours, and the heating was performed under a dry air in the muffle furnace with a flow rate of 10 L/min. The temperature rising rate was 200° C./h. After the heating, the mixture was cooled down to room temperature for 10 hours or longer. In this manner, the composite oxide 901 was obtained (Step S15). The sample subjected to only the first heating was Sample 1 (Comparative example).

Next, the composite oxide 901 was subjected to second heating as shown in Step S16. The composite oxide 901 was put in a crucible made of aluminum oxide, the crucible was covered with a lid, and heating was performed in a muffle furnace. The heating temperature was set to 800° C., the heating time was set to 2 hours, and the heating was performed under a dry air in the muffle furnace with a flow rate of 10 L/min. After the heating, the mixture was cooled down to room temperature for 10 hours or longer. In this manner, the positive electrode active material 100 was obtained (Step S17). The sample subjected to the first heating and the second heating was Sample 2.

Sample 3 was a sample fabricated through only one-time heating as in a manner similar to that of Sample 1 except that the materials were weighed to be Li_{1.01}Co_{0.995}Mg_{0.005}O_{1.99}F_{0.01} in composition. In addition, Sample 4 was a sample fabricated through two-time heating as in a manner similar to that of Sample 2 except that the materials were weighed to be Li_{1.01}Co_{0.995}Mg_{0.005}O_{1.99}F_{0.01} in composition.

Sample 5 was a sample fabricated in a manner similar to that of Sample 2 except that the materials were weighed to be Li_{1.04}Co_{0.98}Mg_{0.02}O_{1.96}F_{0.04} in composition.

Sample 6 was a sample fabricated in a manner similar to that of Sample 2 except that the first heating temperature was set to 950° C. and a flow rate of an oxygen gas at the second heating was set to 10 L/min.

Table 1 shows the conditions of fabricating Sample 1 to Sample 6.

TABLE 1

| | Mixing ratio | First heating | Second heating |
|---|---|---|---|
| Sample 1 | Li_{1.02}Co_{0.99}Mg_{0.01}O_{1.98}F_{0.02} | 1000° C., 10 hr, Dry Air | None |
| Sample 2 | Li_{1.02}Co_{0.99}Mg_{0.01}O_{1.98}F_{0.02} | 1000° C., 10 hr, Dry Air | 800° C., 2 hr, Dry Air |
| Sample 3 | Li_{1.01}Co_{0.995}Mg_{0.005}O_{1.99}F_{0.01} | 1000° C., 10 hr, Dry Air | None |
| Sample 4 | Li_{1.01}Co_{0.995}Mg_{0.005}O_{1.99}F_{0.01} | 1000° C., 10 hr, Dry Air | 800° C., 2 hr, Dry Air |
| Sample 5 | Li_{1.04}Co_{0.98}Mg_{0.02}O_{1.96}F_{0.04} | 1000° C., 10 hr, Dry Air | 800° C., 2 hr, Dry Air |
| Sample 6 | Li_{1.02}Co_{0.99}Mg_{0.01}O_{1.98}F_{0.02} | 950° C., 10 hr, Dry Air | 800° C., 2 hr, O₂ |

The elementary analysis of Sample 1 and Sample 2 manufactured in the above manner was performed. The XPS analysis conditions were as follows.
Measurement device: Quantera II manufactured by PHI, Inc.
X-ray source: monochromatic Al Kα (1486.6 eV)
Detection area: 100 μmϕ
Detection depth: about 4 to 5 nm (extraction angle 45°)
Measurement spectrum: wide, Li1s, Co2p, Ti2p, O1s, C1s, F1s, S2p, Ca2p, Mg1s, Na1s, Zr3d

Table 2 shows the XPS results, and Table 3 shows relative values with reference to one cobalt atom.

TABLE 2

| | Quantative values of elements (atomic %) | | | | | | | | | |
|---|---|---|---|---|---|---|---|---|---|---|
| | Li | Co | O | C | F | S | Ca | Mg | Na | Zr |
| Sample 1 | 12.2 | 17.9 | 47.9 | 14.5 | 1.6 | 0 | 0.4 | 3.7 | 1.4 | 0.3 |
| Sample 2 | 12.5 | 15.9 | 46.6 | 14.7 | 1.4 | 0.2 | 0.7 | 5.5 | 2.2 | 0.3 |

TABLE 3

| | Ratio with respect to Co | | | | | | | | | |
|---|---|---|---|---|---|---|---|---|---|---|
| | Li | Co | O | C | F | S | Ca | Mg | Na | Zr |
| Sample 1 | 0.68 | 1.00 | 2.68 | 0.81 | 0.09 | 0.00 | 0.02 | 0.21 | 0.08 | 0.02 |
| Sample 2 | 0.79 | 1.00 | 2.93 | 0.92 | 0.09 | 0.01 | 0.04 | 0.35 | 0.14 | 0.02 |

As shown in Table 2, the magnesium concentration in Sample 1 is lower than 4.5 atomic %, and that in Sample 2 is higher than or equal to 4.5 atomic %.

### <Cycle Performance>

Next, secondary batteries were fabricated using Sample 1 to Sample 6, and their cycle performance was evaluated.

First, a slurry was formed by mixing the positive electrode active material, AB, and PVDF at the positive electrode active material:AB:PVDF=95:2.5:2.5 (weight ratio), and the slurry was applied onto a current collector of aluminum. As a solvent of the slurry, NMP was used.

After the slurry was applied onto the current collector, the solvent was volatilized. Through the above process, the positive electrode was obtained. The carried amount of the active material was approximately 7.1 mg/cm².

Using the obtained positive electrodes, CR2032 type coin battery cells (a diameter of 20 mm, a height of 3.2 mm) were formed.

A lithium metal was used for a counter electrode.

As an electrolyte included in an electrolyte solution, 1 mol/L lithium hexafluorophosphate (LiPF₆) was used. As the electrolyte solution, a solution in which ethylene carbonate (EC) and diethyl carbonate (DEC) were mixed at a volume ratio of EC:DEC=3:7 and vinylene carbonate (VC) was added as an additive at 2 wt % was used.

As a separator, 25-um-thick polypropylene was used.

A positive electrode can and a negative electrode can that were formed using stainless steel (SUS) were used.

A cycle test was performed under the following conditions. The charge voltage was set to 4.6 V. The measurement temperature was set to 25° C. CC/CV charging (0.5 C, 0.05 C cut) and CC discharging (0.5 C, 2.5 V cut) were performed, and a 10-minute break was taken before the next charging. Note that 1 C was set to 137 mA/g in this example and the like.

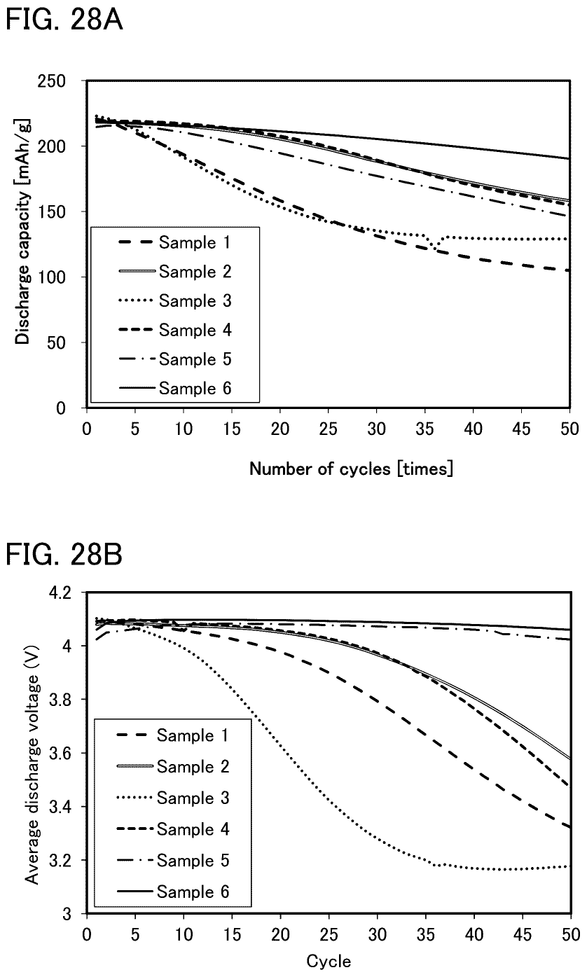

FIG. 28A shows results of cycle tests of the discharge capacity of Sample 1 to Sample 6. As compared with Sample 1 and Sample 3 which were not subjected to the second heating, Sample 2, Sample 4, Sample 5, and Sample 6 which were subjected to the second heating exhibited significantly favorable cycle performance. Among the samples subjected to the second heating, Sample 6 whose baking temperature was 950° C. had the best cycle performance.

FIG. 28B shows the cycle test results of average discharge voltages of Sample 1 to Sample 6. The average discharge voltages of Sample 5 and Sample 6 are inhibited from decreasing even after 50 cycles, and the average discharge voltage in the 50th cycle of Sample 6 was 0.06 V, and that of Sample 5 was 4.02 V. The average discharge voltage is preferably high, in which case high electric energy can be supplied.

On the other hand, the average discharge voltages in the 50th cycle of Sample 1, Sample 2, Sample 3, and Sample 4 were 3.32 V, 3.58 V, 3.17 V, and 3.47 V, respectively. Sample 1 and Sample 3 which were not subjected to the second heating showed large decreases in the average discharge voltage. This was probably because the internal resistance of the battery was increased.

Accordingly, Sample 6 shows excellent cycle performance in terms of the discharge capacity and the average discharge voltage. Although the discharge capacity of Sample 5 is inferior to those of Sample 2, Sample 4, and Sample 6, the cycle performance of the average discharge voltage of Sample 5 is favorable; therefore, Sample 5 was found to be a positive electrode active material capable of supplying high electric energy even through charge and discharge cycles.

Through the second heating, the magnesium concentration in the surface portion increased, so that the magnesium concentration was greater than or equal to 4.5 atomic % and the concentration ratio Mg/Co of magnesium to cobalt was greater than or equal to 0.30. It was also found that the cycle performance becomes excellent through the second heating.

<Crystal Structure after Charging>

Next, secondary batteries were fabricated using Sample 1 to Sample 6 fabricated through the second heating, and the crystal structures thereof after charging were analyzed with XRD.

First, with the use of the positive electrode active materials of Sample 1 to Sample 6, coin cells were fabricated in a manner similar to that of the cycle tests.

CCCV charging at 4.6 V was performed on a coin cell to be subjected to crystal structure analysis after the initial charging (the 1st charging). More specifically, constant current charging at 0.5 C (68.5 mA/g) was performed, and then constant voltage charging was performed until the current value became 0.01 C (1.37 mA/g).

On a coin cell to be subjected to crystal structure analysis after the second charging (the 2nd charging), charging and discharging was performed once under the same conditions as those in the cycle test, and then CCCV charging at 4.6 V was performed. More specifically, constant current charging at 0.5 C (68.5 mA/g) was performed, and then constant voltage charging was performed until the current value became 0.01 C (1.37 mA/g).

Table 4 shows the charge capacity at the initial charging and the second charging.

TABLE 4

Charge capacity (mAh/g)

| | 1st | 2nd |
|---|---|---|
| Sample 1 | 228 | |
| Sample 2 | 222 | 220 |
| Sample 3 | 232 | |
| Sample 4 | 223 | 221 |
| Sample 5 | 218 | 217 |
| Sample 6 | 223 | 219 |

Then, the coin cell in the charged state was disassembled under an argon atmosphere in a glove box, and the positive electrode was taken out and washed with DMC (dimethyl carbonate) to remove the electrolyte solution. Then, the positive electrode was put in an airtight container for XRD measurement in an argon atmosphere. Then, analysis was performed by powder XRD (D8 ADVANCE produced by Bruker AXS) with use of the CuKα1 line. The setting of the XRD apparatus was for powder samples, and the height of the sample was set in accordance with the measurement surface required by the apparatus. The samples were set to be flat without being curved.

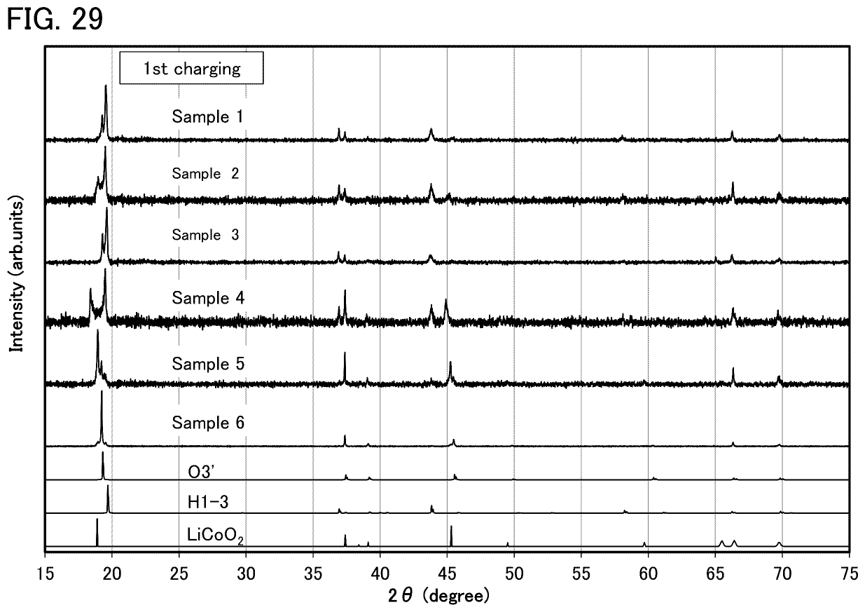

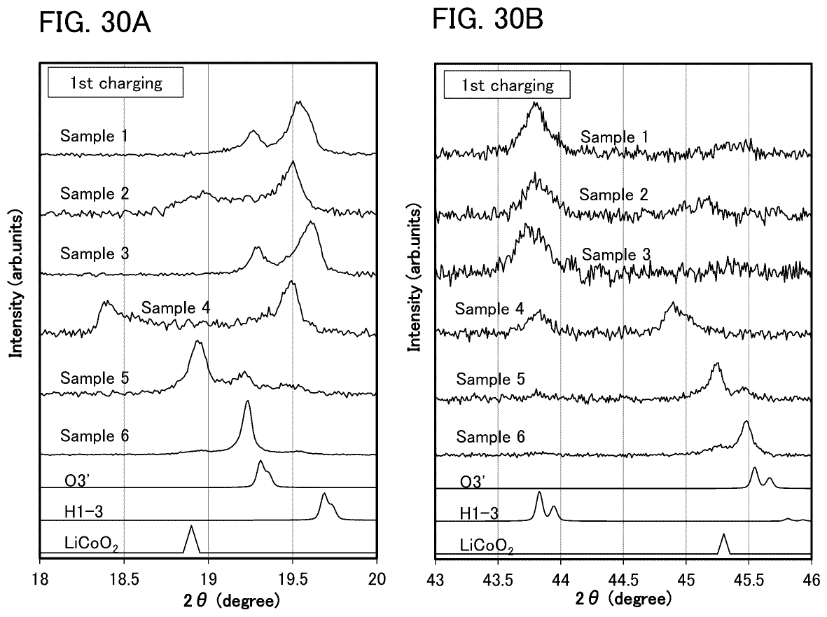

FIG. 29 shows XRD patterns of the positive electrodes of the coin cells using positive electrode active materials of Sample 1 to Sample 6 after the initial charging. For comparison, the patterns of the O3′ type in FIGS. 4 and H1-3 type and LiCoO₂ in FIG. 6 are also shown. FIG. 30A is an enlarged view of a region with 2θ of greater than or equal to 18° and less than or equal to 20. In this region, peaks corresponding the (003) plane of the O3 type and O3′ type crystal structures and the (006) plane of the H1-3 type crystal structure appear. FIG. 30B is an enlarged view of a region with 2θ of greater than or equal to 43° and less than or equal to 46°. In this region, peaks corresponding the (104) plane of the O3 type and O3′ type crystal structures and the (107) plane of the H1-3 type crystal structure appear.

The maximal value, the half width, and the area intensity ratio of each of the peak with of greater than or equal to 18° and less than or equal to 20 and the peak with 2θ of greater than or equal to 43° and less than or equal to 46° after the initial charging were calculated. For the calculation, TOPAS Ver. 3 (crystal structure analysis software fabricated by Bruker AXS) was used, single profile fitting, peak type was PV (position value), and Background chebychev order was 20. Table 5 shows the results.

TABLE 5

| | O3 | | | O3′ | | | H1-3 | | | | |
|---|---|---|---|---|---|---|---|---|---|---|---|
| | 2θ | Half width | | 2θ | Half width | | 2θ | Half width | | Ratio (%) | |
| | (°) | (°) | area | (°) | (°) | area | (°) | (°) | area | H1-3 | O3 + O3′ |
| Sample 1 | — | — | — | 19.20 | 0.13 | 16.8 | 19.47 | 0.13 | 27 | 62 | 38 |
| Sample 2 | 18.99 | 0.27 | 6.7 | 19.37 | 0.34 | 7.5 | 19.54 | 0.11 | 7.4 | 34 | 66 |
| Sample 3 | — | — | — | 19.21 | 0.13 | 16.53 | 19.50 | 0.14 | 26.1 | 61 | 39 |
| Sample 4 | 18.51 | 0.18 | 4.7 | 19.05 | 0.76 | 10 | 19.54 | 0.11 | 8.7 | 37 | 63 |
| Sample 5 | 18.98 | 0.10 | 16.0 | 19.25 | 0.13 | 5.9 | 19.53 | 0.19 | 3.4 | 13 | 87 |
| Sample 6 | 18.94 | 0.26 | 12.3 | 19.20 | 0.05 | 48.19 | 19.48 | 0.18 | 5.9 | 9 | 91 |
| Sample 1 | — | — | — | 45.28 | 0.50 | 54.6 | 43.73 | 0.26 | 96.3 | 64 | 36 |
| Sample 2 | 45.09 | 0.57 | 49.5 | — | — | — | 43.85 | 0.30 | 58.2 | 54 | 46 |
| Sample 3 | — | — | — | 45.23 | 0.84 | 58 | 43.67 | 0.39 | 100.1 | 63 | 37 |
| Sample 4 | 44.99 | 0.27 | 57.1 | — | — | — | 43.87 | 0.27 | 41.5 | 42 | 58 |
| Sample 5 | 45.28 | 0.21 | 71.6 | — | — | — | 43.85 | 2.12 | 125 | 64 | 36 |
| Sample 6 | 45.25 | 0.36 | 64.0 | 45.44 | 0.08 | 54 | 43.84 | 1.29 | 86 | 42 | 58 |

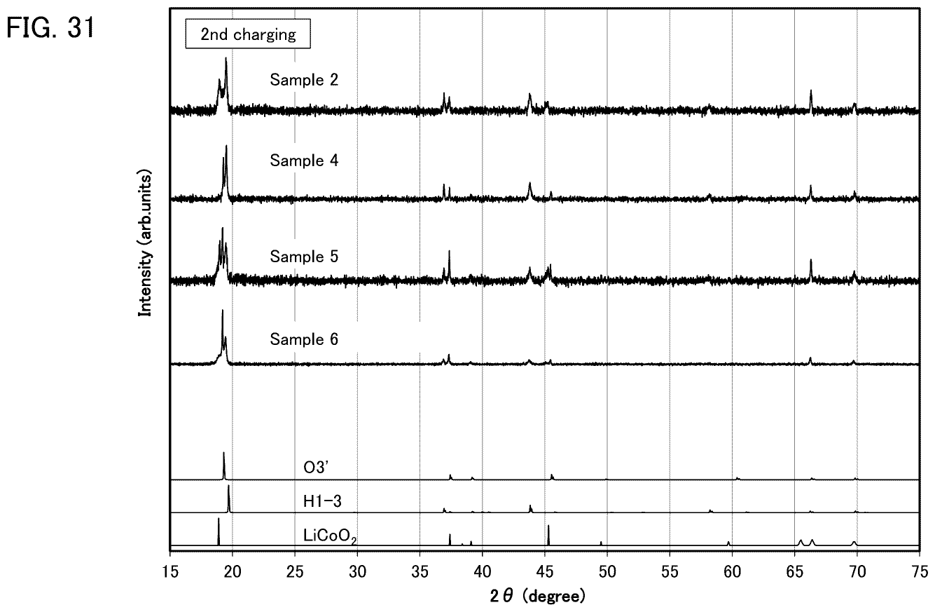

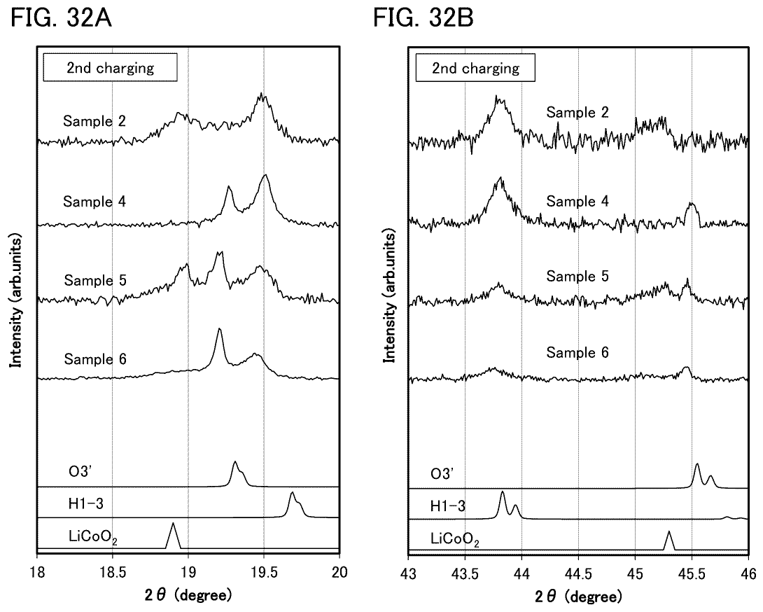

FIG. 31 shows XRD patterns of the positive electrodes of the coin cells using the positive electrode active materials of Sample 2 and Sample 4 to Sample 6 after the second charging. Similarly, FIG. 32A is an enlarged view of a region with 2θ of greater than or equal to 18° and less than or equal to 20. FIG. 32B is an enlarged view of a region with 2θ of greater than or equal to 43° and less than or equal to 46°.

The maximal value, the half width, and the area intensity ratio of each of the peak with of greater than or equal to 18° and less than or equal to 20 and the peak with 2θ of greater than or equal to 43° and less than or equal to 46° after the second charging were calculated in a similar manner, and Table 6 shows the results.

TABLE 6

| | O3 | | | O3′ | | | H1-3 | | | | |
|---|---|---|---|---|---|---|---|---|---|---|---|
| | 2θ | Half width | | 2θ | Half width | | 2θ | Half width | | Ratio (%) | |
| | (°) | (°) | area | (°) | (°) | area | (°) | (°) | area | H1-3 | O3 + O3′ |
| Sample 2 | 19.00 | 0.23 | 7.3 | 19.36 | 0.42 | 9 | 19.55 | 0.13 | 6.6 | 29 | 71 |
| Sample 4 | — | — | — | 19.30 | 0.08 | 8.59 | 19.53 | 0.12 | 14.33 | 63 | 37 |
| Sample 5 | 19.01 | 0.19 | 10.5 | 19.25 | 0.08 | 7.37 | 19.52 | 0.18 | 7.81 | 30 | 70 |
| Sample 6 | 18.94 | 0.46 | 16.5 | 19.18 | 0.05 | 18.3 | 19.41 | 0.16 | 20.98 | 38 | 62 |
| Sample 2 | 45.16 | 0.45 | 48.7 | — | — | — | 43.86 | 0.31 | 59.2 | 55 | 45 |
| Sample 4 | — | — | — | 45.51 | 0.19 | 22.1 | 43.83 | 0.23 | 61.4 | 74 | 26 |
| Sample 5 | 45.25 | 0.44 | 56.9 | 45.49 | 0.06 | 5.7 | 43.84 | 0.34 | 45.3 | 42 | 58 |
| Sample 6 | 45.08 | 0.65 | 70.4 | 45.41 | 0.07 | 10.6 | 43.72 | 0.43 | 68.9 | 46 | 54 |

As shown in Table 5, in the analysis after the initial charging, the area intensity I_{H1-3(006)}/I_{O3′+O3(003)} of Sample 1 and Sample 3, which were not subjected to the second heating, was 62% and 61%, respectively; thus, the both samples exceed 60%. In contrast, the area intensity I_{H1-3(006)}/I_{O3′+O3(003)} of Sample 2 and Sample 4 to Sample 6, which were subjected to the second heating, was less than or equal to 37%; thus, the samples are below 40%.

As shown in Table 6, although the area intensity I_{H1-3(006)}/I_{O3′+O3(003)} after the second charging tends to increase, the area intensity I_{H1-3(006)}/I_{O3′+O3(003)} of each of Sample 2, Sample 5, and Sample 6 was less than or equal to 40%.

Therefore, it was found that the positive electrode active material subjected to the second heating has the O3′ structure after charging. According to the analysis after the initial charging, the area intensity ratio of each of the peak corresponding to the (006) plane of the H1-3 type and the peak corresponding to the (003) plane of the O3′ type and the O3 type was less than or equal to 60%, and more specifically, less than or equal to 40%.

Even when the second heating was not performed, added elements such as magnesium partly entered lithium sites, so that deformation in the c-axis direction after the charging was able to be inhibited to some degree; however, the effect was not sufficient. This is considered to be because the added elements were favorably distributed in only part of the surface portion.

### REFERENCE NUMERALS

100: positive electrode active material, 100a: surface portion, 100b: inner portion, 101: crystal grain boundary, 102: crack

1. A secondary battery comprising a positive electrode,
wherein a positive electrode active material of the positive electrode comprises lithium, a first metal, a second metal, oxygen, and fluorine,
wherein the first metal is at least one of cobalt, nickel, and manganese,
wherein the second metal is at least one of magnesium, aluminum, titanium, zirconium, niobium, lanthanum, yttrium, and hafnium, and
wherein the second metal and fluorine unevenly distributed in a surface portion of the positive electrode active material.

2. The secondary battery according to claim 1,
wherein the second metal is magnesium, and the concentration of magnesium in the surface portion of the positive electrode active material is greater than or equal to 4.5 atomic %, and
wherein each of magnesium and fluorine has a higher concentration as closer to a surface of the positive electrode active material, and has a concentration gradient in which the concentration decreases to ¼ or lower at a depth of 10 nm from the surface.

3. A method of manufacturing a secondary battery,
wherein the secondary battery comprises a positive electrode,
wherein the positive electrode comprises a positive electrode active material,
wherein the positive electrode active material is manufactured through a first manufacturing step to a third manufacturing step,
wherein in the first manufacturing step, a lithium source, a first metal source, a second metal source, and a fluorine source are mixed to form a mixture,
wherein in the second manufacturing step, the mixture formed in the first manufacturing step is heated to form a composite oxide, and
wherein in the third manufacturing step, the composite oxide formed in the second manufacturing step is heated.

4. A method of manufacturing a secondary battery,
wherein the secondary battery comprises a positive electrode,
wherein the positive electrode comprises a positive electrode active material,
wherein the positive electrode active material is manufactured through a first manufacturing step to a third manufacturing step,
wherein in the first manufacturing step, a lithium source, a first metal source, a second metal source, and a fluorine source are mixed to form a mixture,
wherein in the second manufacturing step, the mixture formed in the first manufacturing step is put in a container, the container is covered with a lid, and heating is performed to form a composite oxide, and
wherein in the third manufacturing step, the composite oxide formed in the second manufacturing step is put in a container, the container is covered with a lid, and heating is performed.

5. The method of manufacturing a secondary battery, according to claim 3,
wherein the heating in the second manufacturing step is performed at a temperature higher than or equal to 900° C. and lower than or equal to 1100° C. for longer than or equal to 5 hours and shorter than or equal to 20 hours, and
wherein the heating in the third manufacturing step is performed at a temperature higher than or equal to 742° C. and lower than or equal to 920° C. for longer than or equal to an hour and shorter than or equal to 10 hours.

6. A secondary battery comprising a positive electrode,
wherein a ratio of an area intensity I_{H1-3(006)} to an area intensity I_{H1-3(006)} (I_{H1-3(006)}/I_{O3′+O3(003)}) is less than or equal to 60%, when the positive electrode is analyzed by powder X-ray diffraction with use of CuKα1 line after a charging in a lithium ion secondary battery,
wherein the area intensity I_{H1-3(006)} is integration with 2θ of greater than or equal to 18.00° and less than 19.30°,
wherein the area intensity I_{O3′+O3(003)} is integration with 2θ of greater than or equal to 19.30° and less than or equal to 20.00°, and
wherein, in the charging, the lithium ion secondary battery which comprises the positive electrode and lithium metal for a negative electrode are subjected to constant current charging in an environment of 25° C. until battery voltage becomes 4.6 V, and subjected to constant voltage charging until a current value becomes 0.01 C.

7. The secondary battery according to claim 6,
wherein the half width of a peak with 2θ of greater than or equal to 18.5° and less than or equal to 20° is less than or equal to 0.2°, and
wherein the half width of a peak with 2θ of greater than or equal to 45° and less than or equal to 46° is less than or equal to 0.2°.

8. An electronic device comprising the secondary battery according to claim 1.

9. A vehicle comprising the secondary battery according to claim 1.

10. The method of manufacturing a secondary battery, according to claim 4,
wherein the heating in the second manufacturing step is performed at a temperature higher than or equal to 900° C. and lower than or equal to 1100° C. for longer than or equal to 5 hours and shorter than or equal to 20 hours, and
wherein the heating in the third manufacturing step is performed at a temperature higher than or equal to 742° C. and lower than or equal to 920° C. for longer than or equal to an hour and shorter than or equal to 10 hours.

11. The secondary battery according to claim 6,
wherein 1 C is set to 137 mA/g.
